(19) United States
(12) Patent Application Publication
(10) Pub. No.: US 2025/0016459 A1
(43) Pub. Date: Jan. 9, 2025

(54) IMAGING APPARATUS

(71) Applicant: Panasonic Intellectual Property Management Co., Ltd., Osaka (JP)

(72) Inventors: Shunsuke TOMOMATSU, Osaka (JP); Kazuhiro Yamada, Osaka (JP)

(21) Appl. No.: 18/894,712

(22) Filed: Sep. 24, 2024

Related U.S. Application Data
(63) Continuation of application No. PCT/JP2023/011070, filed on Mar. 22, 2023.

(30) Foreign Application Priority Data
Mar. 29, 2022 (JP) 2022-053410

(51) Int. Cl. H04N 23/75; G01S 7/481; G01S 7/51; G01S 17/89; H04N 23/71; H04N 23/73; H04N 23/80

(52) U.S. Cl. CPC H04N 23/75; G01S 7/4816; G01S 7/51; G01S 17/89; H04N 23/71; H04N 23/73; H04N 23/80

(57) ABSTRACT

An imaging apparatus captures an image of a person passing through a predetermined space, using a sub-terahertz wave. The imaging apparatus includes an emitter that emits the sub-terahertz wave to the person, and a detection device. The detection device includes: an optical system that images a reflected wave which is the sub-terahertz wave emitted from the emitter and reflected by the person; and a plurality of pixels that are disposed in a planar arrangement and each receive the reflected wave imaged by the optical system, and generates an image based on cumulative intensities, each being obtained by accumulating an intensity of the reflected wave received by each of the plurality of pixels for a predetermined time, and the planar arrangement of the plurality of pixels. The predetermined time is λ/1778 seconds or longer, when the wavelength of the sub-terahertz wave is taken as λ mm.

### CROSS REFERENCE TO RELATED APPLICATIONS

This is a continuation application of PCT International Application No. PCT/JP2023/011070 filed on Mar. 22, 2023, designating the United States of America, which is based on and claims priority of Japanese Patent Application No. 2022-053410 filed on Mar. 29, 2022. The entire disclosures of the above-identified applications, including the specifications, drawings and claims are incorporated herein by reference in their entirety.

### FIELD

The present disclosure relates to an imaging apparatus.

### BACKGROUND

Conventionally, imaging apparatuses which capture images of imaging targets using terahertz waves and sub-terahertz waves have been known. For example, Patent Literature (PTL) 1 discloses an imaging apparatus which obtains an image of an imaging target using a sub-terahertz wave.

### CITATION LIST

### Patent Literature

PTL 1: WO2021/255964

### SUMMARY

### Technical Problem

To increase the image quality, for example, imaging apparatuses which capture images of imaging targets using sub-terahertz waves are required to control uneven brightness in the images that occurs regardless of the properties of the imaging targets of reflecting sub-terahertz waves. Utilizing the difference between a human body and a dangerous object in the properties of reflecting sub-terahertz waves, for example, images that are captured using sub-terahertz waves are used to detect whether a person has a dangerous object. In this case, when the images include uneven brightness that occurs regardless of the property of the imaging target of reflecting a sub-terahertz wave, the accuracy of dangerous object detection decreases.

In view of the above, the present disclosure provides an imaging apparatus capable of controlling uneven brightness that occurs in an image regardless of the property of an imaging target of reflecting a sub-terahertz wave.

### Solution to Problem

An imaging apparatus according to an aspect of the present disclosure is an imaging apparatus that captures an image of an imaging target passing through a predetermined region, using a sub-terahertz wave, the imaging apparatus including: an emitter that emits the sub-terahertz wave to the imaging target; and a detection device that includes (i) an optical system that images a reflected wave which is the sub-terahertz wave emitted from the emitter and reflected by the imaging target and (ii) a plurality of pixels that are disposed in a planar arrangement and each receive the reflected wave imaged by the optical system, and generates an image, based on cumulative intensities and the planar arrangement of the plurality of pixels, the cumulative intensities, each being obtained by accumulating an intensity of the reflected wave received by each of the plurality of pixels for a predetermined time, wherein the predetermined time is λ/1778 seconds or longer, when a wavelength of the sub-terahertz wave is taken as A mm.

An imaging apparatus according to an aspect of the present disclosure is an imaging apparatus that captures an image of an imaging target passing through a predetermined region, using a sub-terahertz wave, the imaging apparatus including: an emitter that emits the sub-terahertz wave to the imaging target; a detection device that includes (i) an optical system that images a reflected wave which is the sub-terahertz wave emitted from the emitter and reflected by the imaging target and (ii) a plurality of pixels that are disposed in a planar arrangement and each receive the reflected wave imaged by the optical system, and generates an image, based on cumulative intensities and the planar arrangement of the plurality of pixels, the cumulative intensities, each being obtained by accumulating an intensity of the reflected wave received by each of the plurality of pixels for a predetermined time; a detector that detects a traveling state of the imaging target passing through the predetermined region; and a controller that determines the predetermined time based on the traveling state, and causes the detection device to generate the image based on the cumulative intensities accumulated for the predetermined time determined.

### Advantageous Effects

With the imaging apparatus according to an aspect of the present disclosure, it is possible to control uneven brightness that occurs in an image regardless of the property of an imaging target of reflecting a sub-terahertz wave.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for explaining the occurrence of uneven brightness in image capturing that utilizes a sub-terahertz wave.

FIG. 2 is a schematic diagram showing an appearance of an imaging apparatus according to an embodiment.

FIG. 3 is a block diagram showing the configuration of the imaging apparatus according to the embodiment.

FIG. 4 is a schematic diagram showing the imaging apparatus according to the embodiment viewed from above.

FIG. 5 is a diagram showing an example of the circuit configuration of an image sensor according to the embodiment.

FIG. 6 is a timing chart for explaining an operation performed by the image sensor shown in FIG. 5.

FIG. 7 is a diagram showing another example of the circuit configuration of the image sensor according to the embodiment.

FIG. 8 is a timing chart for explaining an operation performed by the image sensor shown in FIG. 7.

FIG. 9 is a plan view showing one example of a phase difference plate according to the embodiment.

FIG. 10 is a cross-sectional view showing one example of the phase difference plate according to the embodiment.

FIG. 11 is a schematic diagram for explaining an example of the movement of one example of the phase difference plate according to the embodiment.

FIG. 12 is a plan view showing another example of the phase difference plate according to the embodiment.

FIG. 13 is a schematic diagram for explaining an example of the movement of another example of the phase difference plate according to the embodiment.

FIG. 14 is a plan view showing still another example of the phase difference plate according to the embodiment.

FIG. 15 is a schematic diagram for explaining an example of the movement of the still another example of the phase difference plate according to the embodiment.

FIG. 16 is a diagram showing an example of images outputted by a detector according to the embodiment.

FIG. 17 is a side view for explaining another example of the disposition of the detector according to the embodiment.

FIG. 18 is a top view for explaining still another example of the disposition of the detector according to the embodiment.

FIG. 19 is a diagram showing an example of images outputted by the detector shown in FIG. 17.

FIG. 20 is a diagram showing an example of images outputted by the detector shown in FIG. 18.

FIG. 21 is a side view showing an example of the case where the detector according to the embodiment is configured in the form of a pressure sensor.

FIG. 22 is a top view showing an example of the case where the detector according to the embodiment is configured in the form of a distance sensor.

FIG. 23 is a side view showing an example of the case where the detector according to the embodiment is configured in the form of a human sensor.

FIG. 24 is a top view showing an example of the case where the detector according to the embodiment is configured in the form of a speed sensor.

FIG. 25 is a schematic diagram showing an imaging apparatus according to Variation 1 of the embodiment viewed from above.

FIG. 26 is a schematic diagram for explaining an example of the movement of one example of a phase difference plate according to Variation 1 of the embodiment.

FIG. 27 is a schematic diagram for explaining an example of the movement of another example of the phase difference plate according to Variation 1 of the embodiment.

FIG. 28 is a schematic diagram for explaining an example of the movement of still another example of the phase difference plate according to Variation 1 of the embodiment.

FIG. 29 is a schematic diagram showing an imaging apparatus according to Variation 2 of the embodiment viewed from above.

FIG. 30 is a schematic diagram showing an imaging apparatus according to Variation 3 of the embodiment viewed from above.

FIG. 31 is a schematic diagram for explaining an example of the movement of a light source according to Variation 3 of the embodiment.

FIG. 32 is a schematic diagram for explaining another example of the movement of the light source according to Variation 3 of the embodiment.

FIG. 33 is a schematic diagram showing an imaging apparatus according to Variation 4 of the embodiment viewed from above.

FIG. 34 is a diagram for explaining a change in the optical path length of a sub-terahertz wave caused by a person who is traveling.

FIG. 35A is a schematic diagram showing an example of the arrangement of pixels in a pixel array in the image sensor according to the embodiment.

FIG. 35B is a schematic diagram showing an example of an imaging distance of a detection device.

FIG. 36 is a flowchart of Example Operation 1 performed by the imaging apparatuses according to the embodiment and variations.

FIG. 37 is a flowchart of Example Operation 2 performed by the imaging apparatuses according to the embodiment and variations.

FIG. 38 is a flowchart of Example Operation 3 performed by the imaging apparatuses according to the embodiment and variations.

FIG. 39 is a flowchart of Example Operation 4 performed by the imaging apparatuses according to the embodiment and variations.

FIG. 40 is a flowchart of Example Operation 5 performed by the imaging apparatuses according to the embodiment and variations.

FIG. 41 is a flowchart of Example Operation 6 performed by the imaging apparatuses according to the embodiment and variations.

### DESCRIPTION OF EMBODIMENT

### (Circumstances Leading to the Present Disclosure)

As described above, there is a need to control uneven brightness that occurs regardless of the property of an imaging target of reflecting a sub-terahertz wave. The inventors have found that a problem as described below arises when an image of the imaging target is captured using a sub-terahertz wave.

The wavelength of a sub-terahertz wave is longer than that of visible light. Thus, when used for image capturing, the sub-terahertz wave is specularly reflected by the imaging target, such as a human body. This makes it difficult for the image sensor to efficiently receive the reflected wave from the imaging target. To make it easier for the image sensor to receive the reflected wave from the imaging target, for example, the sub-terahertz wave is caused to be diffusely reflected by a reflector, and then emitted to the imaging target, thereby irradiating the imaging target with the sub-terahertz wave from various angles. When such a method is used, a sub-terahertz wave having different optical path lengths, from the light source that emits the sub-terahertz wave to the imaging target, enters the imaging target. As a result, the sub-terahertz wave that enters the imaging target includes components of various phases.

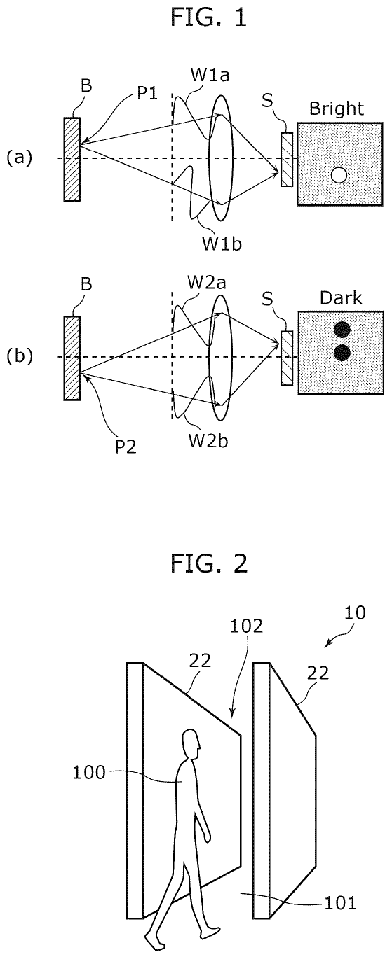

FIG. 1 is a diagram for explaining the occurrence of uneven brightness in image capturing that utilizes a sub-terahertz wave. FIG. 1 shows the cases where images are captured of imaging target B having a plate shape that uniformly reflects a sub-terahertz wave. (a) in FIG. 1 schematically shows the case where an image is captured of a reflected wave reflected at certain position P1 on imaging target B. (b) in FIG. 1 schematically shows the case where an image is captured of a reflected wave reflected at position P2 on imaging target B that is different from position P1. In FIG. 1, the reflected wave which is indicated by arrows, is imaged on image sensor S. FIG. 1 also schematically shows waveforms W1a, W1b, W2a, and W2b of the reflected wave on the arrows indicating the reflected wave.

As described above, the sub-terahertz wave that enters imaging target B includes components of various phases. As such, the distribution of the phases of the reflected wave from imaging target B with respect to the reflection angles can differ depending on reflection positions. For example, as indicated by waveforms W1a and W1b in (a) in FIG. 1, two components of the reflected wave reflected at position P1 are components of the same phase. As such, these components of the same phase interfere with each other to be bright when imaged on image sensor S. Meanwhile, as indicated by waveforms W2a and W2b in (b) in FIG. 1, two components of the reflected wave reflected at position P2 are components of different phases (e.g., shifted by half the wavelength). As such, these components of different phases interfere each other to be dark when imaged on image sensor S. As described above, unevenness occurs in brightness of the resulting image, although the image of imaging target B having uniform reflection property is captured.

As described above, the inventors have found that uneven brightness can occur in the resulting image that is captured using a sub-terahertz wave, because the distribution of the phases of the reflected wave with respect to the reflection angles differs depending on reflection positions on the imaging target. Note that, in the present specification, “the distribution of the phases of the reflected wave with respect to the reflection angles” is also simply referred to as “the angular distribution of the phases of the reflected wave”.

In view of the above problem, the present disclosure provides an imaging apparatus capable of controlling uneven brightness that occurs in an image regardless of the property of an imaging target of reflecting a sub-terahertz wave.

The following shows examples of the imaging apparatus according to the present disclosure as a summary of the present disclosure.

An imaging apparatus according to a first aspect of the present disclosure is an imaging apparatus that captures an image of an imaging target passing through a predetermined region, using a sub-terahertz wave. Such imaging apparatus includes: an emitter that emits the sub-terahertz wave to the imaging target; and a detection device that includes (i) an optical system that images a reflected wave which is the sub-terahertz wave emitted from the emitter and reflected by the imaging target and (ii) an image sensor that includes a plurality of pixels that are disposed in a planar arrangement and each receive the reflected wave imaged by the optical system, and generates an image, based on cumulative intensities and the planar arrangement of the plurality of pixels, the cumulative intensities, each being obtained by accumulating an intensity of the reflected wave received by each of the plurality of pixels for a predetermined time. Here, the predetermined time is λ/1778 seconds or longer, when a wavelength of the sub-terahertz wave is taken as λ mm.

With this, when the traveling speed of the imaging target is taken as 3.2 km per hour (=889 mm per second), which is the traveling speed of a typical person, the imaging target travels by half the wavelength of the sub-terahertz wave or more during the predetermined time. As a result, a change occurs, before and after the imaging target travels in the predetermined time, in the optical path length, through which the sub-terahertz wave emitted from the emitter travels to enter the image sensor after being reflected by the imaging target, by the wavelength of the sub-terahertz wave or more. This enables the image sensor to accumulate, in the predetermined time, the intensity between two patterns of the angular distribution of the phases of the reflected wave that are shifted by the wavelength of the sub-terahertz wave. As a result, the image sensor effectively accumulates the intensity of the reflected wave with different angular distributions of the phases, and unevenness in brightness caused by interference described above is leveled out. It is thus possible for the imaging apparatus according to this aspect to control the foregoing uneven brightness that occurs in the image regardless of the property of the imaging target of reflecting a sub-terahertz wave.

Also, an imaging apparatus according to a second aspect of the present disclosure is, for example, the imaging apparatus according to the first aspect. Such imaging apparatus includes: a detector that detects a traveling state of the imaging target passing through the predetermined region; and a controller that controls an operation performed by the imaging apparatus when the traveling state is stationary.

With this, in the imaging apparatus, the controller controls the operation of the imaging apparatus, when the optical path length, through which the sub-terahertz wave emitted from the emitter travels to enter the image sensor after being reflected by the imaging target, is less likely to change in the predetermined time due to that the traveling state of the imaging target is stationary. Thus, by appropriately controlling the operation of the imaging apparatus, it is possible to control uneven brightness that occurs in the image regardless of the property of the imaging target of reflecting a sub-terahertz wave, even when the imaging target is stationary.

Also, an imaging apparatus according to a third aspect of the present disclosure is, for example, the imaging apparatus according to the second aspect. In such imaging apparatus, the controller determines the predetermined time based on the traveling state, and causes the image sensor to generate the image based on the cumulative intensities accumulated for the predetermined time determined.

Also, an imaging apparatus according to a fourth aspect is an imaging apparatus that captures an image of an imaging target passing through a predetermined region, using a sub-terahertz wave. Such imaging apparatus includes: an emitter that emits the sub-terahertz wave to the imaging target; a detection device that includes (i) an optical system that images a reflected wave which is the sub-terahertz wave emitted from the emitter and reflected by the imaging target and (ii) an image sensor that includes a plurality of pixels that are disposed in a planar arrangement and each receive the reflected wave imaged by the optical system, and generates an image, based on cumulative intensities and the planar arrangement of the plurality of pixels, the cumulative intensities, each being obtained by accumulating an intensity of the reflected wave received by each of the plurality of pixels for a predetermined time; a detector that detects a traveling state of the imaging target passing through the predetermined region; and a controller that determines the predetermined time based on the traveling state, and causes the image sensor to generate the image based on the cumulative intensities accumulated for the predetermined time determined.

The optical path length, through which the sub-terahertz wave emitted from the emitter travels to enter the image sensor after being reflected by the imaging target, changes in response to the travel of the imaging target. Also, the amount of change in the above optical path length in the predetermined time during which the image sensor accumulates the intensity of the reflected wave is determined by the traveling state of the imaging target, such as the traveling speed. Further, since the angular distribution of the phase of the reflected wave to be received by the image sensor also changes in response to a change in the above optical path length, the traveling state of the imaging target affects the angular distribution of the phase of the reflected wave to be received by the image sensor in the predetermined time. The more likely the angular distribution of the phase of the reflected wave to be received by the image sensor changes in the predetermined time, the more reliably the image sensor can accumulate the intensity of the reflected wave with different angular distributions of the phases and control uneven brightness in the image. Thus, whether uneven brightness is likely to occur in an image generated by the image sensor depends on the traveling state of the imaging target. For this reason, by the controller determining the predetermined time on the basis of the traveling state of the imaging target, it is possible to appropriately control the amount of change in the above optical path length in the predetermined time that affects unevenness in brightness in the image. It is thus possible to control uneven brightness in the image that occurs regardless of the property of the imaging target of reflecting a sub-terahertz wave.

Also, an imaging apparatus according to a fifth aspect of the present disclosure is, for example, the imaging apparatus according to any one of the second aspect to the fourth aspect. In such imaging apparatus, the detector detects, as the traveling state, a traveling speed at which the imaging target passes through the predetermined region, and the controller determines that the traveling state of the imaging target is stationary when the traveling speed is less than a predetermined speed.

With this, the traveling state is determined on the basis of the traveling speed of the imaging target, which in particular affects the optical path length, through which the sub-terahertz wave emitted from the emitter travels to enter the image sensor after being reflected by the imaging target.

Also, an imaging apparatus according to a sixth aspect of the present disclosure is, for example, the imaging apparatus according to any one of the second aspect to the fifth aspect. In such imaging apparatus, the controller causes the detection device to stop generating the image when the traveling state is stationary.

With this, no image is generated when uneven brightness, which occurs in the image regardless of the property of the imaging target of reflecting a sub-terahertz wave, is likely to be large. With this, since no image is outputted that leads to a decrease in the accuracy of dangerous object detection, when images are used for dangerous object detection. This prevents false detection.

Also, an imaging apparatus according to a seventh aspect of the present disclosure is, for example, the imaging apparatus according to any one of the second aspect to the fifth aspect. Such imaging apparatus includes a display that displays the image, and the controller causes the display to stop displaying the image or to overlay another image onto the image when the traveling state is stationary.

With this, the image generated by the detection device will not be displayed as it is when uneven brightness, which occurs in the image regardless of the property of the imaging target of reflecting a sub-terahertz wave, is likely to be large. This prevents the user, for example, from mistakenly recognizing the image generated by detection device 30, when such user is checking the image.

Also, an imaging apparatus according to an eighth aspect of the present disclosure is, for example, the imaging apparatus according to any one of the second aspect to the seventh aspect. Such imaging apparatus includes an alarm that issues a warning, and the controller causes the alarm to issue the warning when the traveling state is stationary.

With this, even when the amount of change in the above optical path length is small or does not occur in the predetermined time due to that the traveling state of the imaging target is stationary, a warning is issued to the imaging target to prompt the imaging target to change the traveling state, by, for example, increasing the traveling speed.

Also, an imaging apparatus according to a ninth aspect of the present disclosure is, for example, the imaging apparatus according to any one of the second aspect to the fifth aspect. Such imaging apparatus includes a phase modulator that changes an angular distribution of a phase of the reflected wave to be received by the image sensor during an exposure period in which the image sensor generates the image, and the controller causes the phase modulator to change the angular distribution of the phase when the traveling state is stationary.

With this, even when the amount of change in the above optical path length is small or does not occur in the predetermined time due to that the traveling state of the imaging target is stationary, it is possible for the phase modulator to change the angular distribution of the phase of the reflected wave to be received by the image sensor. It is thus possible to control uneven brightness in the image that occurs regardless of the property of the imaging target of reflecting a sub-terahertz wave.

Also, an imaging apparatus according to a tenth aspect of the present disclosure is, for example, the imaging apparatus according to the ninth aspect. In such imaging apparatus, the emitter includes: a light source that emits the sub-terahertz wave; and a reflector that diffusely reflects the sub-terahertz wave emitted from the light source to irradiate the imaging target with the sub-terahertz wave diffusely reflected, and the phase modulator includes: a phase difference plate that is disposed between the light source and the reflector, and changes a phase of the sub-terahertz wave that transmits through the phase difference plate; and a phase difference plate driver that moves the phase difference plate under a predetermined condition.

With this, since the phase of the sub-terahertz wave emitted to the imaging target changes, it is possible to effectively change the angular distribution of the phase of the reflected wave to be received by the image sensor in the predetermined time.

Note that, in the present specification, “diffusely reflected” means that a sub-terahertz wave incident on a reflector at macroscopically one incident angle is reflected at a plurality of reflection angles by a structure having an uneven surface with microscopic asperities.

Also, an imaging apparatus according to an eleventh aspect of the present disclosure is, for example, the imaging apparatus according to the ninth aspect. In such imaging apparatus, the phase modulator includes: a phase difference plate that is disposed on an optical path of the reflected wave, between the predetermined region and the image sensor, and changes the phase of the reflected wave that transmits through the phase difference plate; and a phase difference plate driver that moves the phase difference plate under a predetermined condition.

With this, since the phase of the reflected wave from the imaging target that enters the image sensor changes, it is possible to effectively change the angular distribution of the phase of the sub-terahertz wave received by the image sensor in the predetermined time.

Also, an imaging apparatus according to a twelfth aspect of the present disclosure is, for example, the imaging apparatus according to the ninth aspect. In such imaging apparatus, the phase modulator forms at least part of the optical system, the optical system includes, as the phase modulator, a mirror system that reflects the reflected wave to image the reflected wave onto the image sensor, the mirror system includes a plurality of mirrors, and each of the plurality of mirrors changes the phase of the reflected wave that is reflected during the exposure period of the image sensor.

With this, the phase modulator and the detection device are integrally formed, thereby changing the angular distribution of the phase of the reflected wave to be received by the image sensor.

Also, an imaging apparatus according to a thirteenth aspect of the present disclosure is, for example, the imaging apparatus according to the ninth aspect. In such imaging apparatus, the emitter includes: a light source that emits the sub-terahertz wave; and a reflector that diffusely reflects the sub-terahertz wave emitted from the light source to irradiate the imaging target with the sub-terahertz wave diffusely reflected, and the phase modulator includes a light source driver that moves the light source under a predetermined condition to change the angular distribution of the phase.

With this, the optical path length changes in response to the movement of the light source. This effectively changes the angular distribution of the phase of the reflected wave to be received by the image sensor in the predetermined time.

Also, an imaging apparatus according to a fourteenth aspect of the present disclosure is, for example, the imaging apparatus according to the ninth aspect. In such imaging apparatus, the emitter includes: a light source that emits the sub-terahertz wave; and a reflector that diffusely reflects the sub-terahertz wave emitted from the light source to irradiate the imaging target with the sub-terahertz wave diffusely reflected, and the phase modulator includes a reflector driver that moves the reflector under a predetermined condition to change the angular distribution of the phase.

With this, the optical path length changes in response to the movement of the reflector. This effectively changes the angular distribution of the phase of the reflected wave to be received by the image sensor in the predetermined time.

Also, an imaging apparatus according to a fifteenth aspect of the present disclosure is, for example, the imaging apparatus according to any one of the ninth aspect to the fourteenth aspect. In such imaging apparatus, the phase modulator includes a conveyer that moves the imaging target by half the wavelength of the sub-terahertz wave or more within the predetermined region during the exposure period of the image sensor to change the angular distribution of the phase.

With this, since the amount of travel of the imaging target in the exposure period becomes large, a change in the optical path length also becomes large. This effectively changes the angular distribution of the phase of the reflected wave to be received by the image sensor in the exposure period.

Also, an imaging apparatus according to a sixteenth aspect of the present disclosure is, for example, the imaging apparatus according to any one of the first aspect to the fifteenth aspect. In such imaging apparatus, the predetermined time is L/27800 seconds or less, when a shortest imaging distance in the detection device is taken as L mm.

With this, a change in the positions of pixels at which the reflected wave from the imaging target enters, which is a change caused by the travel of the imaging target in the predetermined time, is likely to be half a pixel or less in length. This enables blurring to be controlled in the generated image.

Also, an imaging apparatus according to a seventeenth aspect of the present disclosure is, for example, the imaging apparatus according to any one of the first aspect to the sixteenth aspect. In such imaging apparatus, the predetermined time is a duration of an exposure period in one frame of the image sensor.

With this, it is possible for the image sensor to generate an image within the exposure period of one frame. This shortens the time required to generate one image.

Also, an imaging apparatus according to an eighteenth aspect of the present disclosure is, for example, the imaging apparatus according to any one of the first aspect to the seventeenth aspect. In such imaging apparatus, the predetermined time is λ/254 seconds or longer.

With this, the above optical path length changes more significantly before and after the travel of the imaging target in the predetermined time. It is thus possible to control uneven brightness that occurs in the image regardless of the property of the imaging target of reflecting a sub-terahertz wave.

Also, an imaging apparatus according to a nineteenth aspect of the present disclosure is, for example, the imaging apparatus according to any one of the first aspect to the eighteenth aspect. In such imaging apparatus, a frequency of the sub-terahertz wave is between 0.05 THz and 2 THz, inclusive, and the wavelength of the sub-terahertz wave is between 0.15 mm and 6 mm, inclusive.

Hereinafter, a certain exemplary embodiment is described in greater detail with reference to the accompanying Drawings.

The exemplary embodiment described below shows a general or specific example. The numerical values, shapes, materials, elements, the arrangement and connection of the elements, steps, the processing order of the steps etc. shown in the following exemplary embodiment are mere examples, and therefore do not limit the scope of the appended Claims and their equivalents. Therefore, among the elements in the following exemplary embodiment, those not recited in any one of the independent claims are described as optional elements. The drawings are not necessarily precise illustrations. For example, the drawings are not necessarily illustrated to the same scale. Elements that are substantially the same are given the same reference signs throughout the drawings, and redundant descriptions can be omitted or simplified.

Also, in the present specification, terms indicating a relationship between elements such as “parallel”, terms indicating the shapes of elements such as “flat plate”, terms indicating time such as “immediately after”, and numerical value ranges do not express their strict meanings only, but also include substantially equivalent ranges, e.g., differences of several percent.

### Embodiment

### [Configuration]

First, a configuration of an imaging apparatus according to an embodiment is described.

FIG. 2 is a schematic diagram showing an appearance of imaging apparatus 10 according to the present embodiment. In FIG. 2, the illustration of the elements other than reflectors 22 is omitted.

As shown in FIG. 2, imaging apparatus 10 is, for example, an imaging apparatus that emits a sub-terahertz wave to person 100 when, for example, person 100 passes through imaging space 102 above pathway 101 interposed between reflectors 22, and captures an image, on the basis of the reflected wave that is the sub-terahertz wave emitted by imaging apparatus 10 and reflected by person 100. Stated differently, imaging apparatus 10 captures an image of person 100 who passes through imaging space 102, using a sub-terahertz wave. Imaging space 102 is, for example, a space interposed between reflectors 22, of the space above pathway 101. Also, imaging apparatus 10 captures, for example, an image of a dangerous object such as a blade concealed under clothing of person 100. Person 100 and the dangerous object such as a blade concealed under clothing of person 100 are each one example of the imaging target. Also, imaging space 102 is an example of the predetermined region. Note that imaging space 102 is not limited to a specific space, and thus may be any spaces in which a sub-terahertz wave can be emitted and an image of the imaging target in imaging space 102 can be captured using the sub-terahertz wave.

Note that “sub-terahertz wave” in the present specification means an electromagnetic wave of a frequency between 0.05 THz and 2 THz, inclusive, and of a wavelength between 0.15 mm and 6 mm, inclusive. The sub-terahertz wave in the present specification may also be an electromagnetic wave of a frequency between 0.08 THz and 1 THz, inclusive, and of a wavelength between 0.3 mm and 3.75 mm, inclusive.

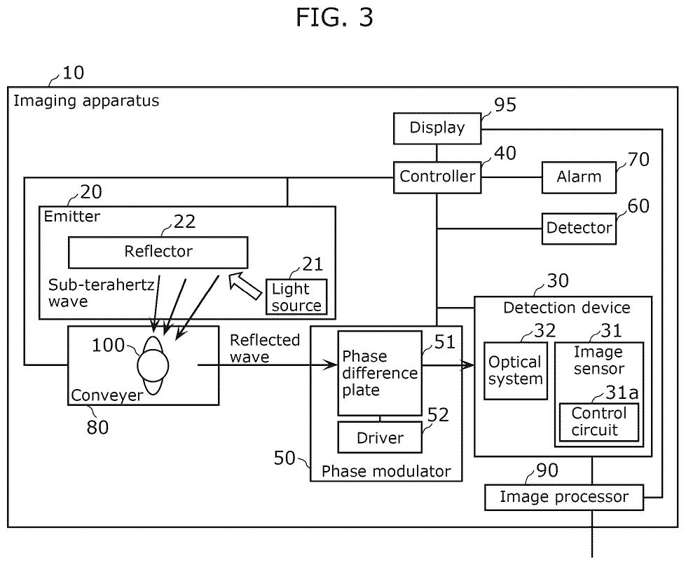

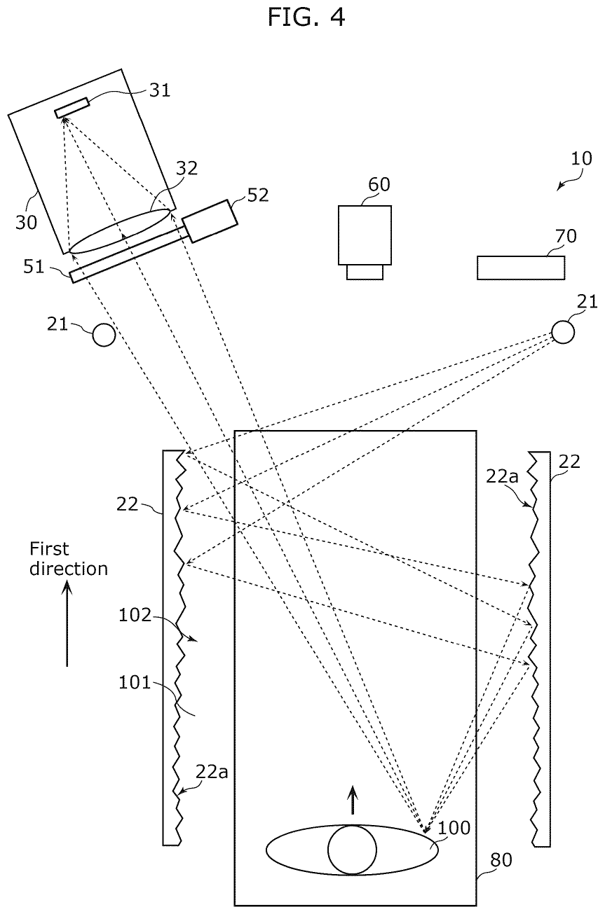

Hereinafter, the elements of imaging apparatus 10 are described in detail. FIG. 3 is a block diagram showing the configuration of imaging apparatus 10 according to the present embodiment. FIG. 4 is a schematic diagram showing imaging apparatus 10 according to the present embodiment viewed from above. FIG. 4 illustrates person 100 passing through imaging space 102. FIG. 4 also indicates, by arrows, an example of the courses of travel of a sub-terahertz wave emitted from light source 21.

Imaging apparatus 10 includes emitter 20, detection device 30, controller 40, phase modulator 50, detector 60, alarm 70, conveyer 80, image processor 90, and display 95.

### [Emitter]

Emitter 20 emits a sub-terahertz wave to person 100. Emitter 20 includes, for example, light source 21 that emits a sub-terahertz wave and reflector 22 that diffusely reflects the sub-terahertz wave emitted from light source 21. In the present embodiment, emitter 20 includes two light sources 21 and two reflectors 22.

Each of light sources 21 is a light source that emits a sub-terahertz wave toward reflector 22. More specifically, light source 21 emits a sub-terahertz wave toward surface 22a of reflector 22. As shown in FIG. 4, light source 21 emits a sub-terahertz wave toward reflector 22 in a manner that the sub-terahertz wave emitted by light source 21 is at least partially diffusely reflected one or more times at reflector 22. Part of the sub-terahertz wave emitted by light source 21 may also enter person 100 directly. Light source 21 emits, for example, a sub-terahertz wave with an approximately uniform wavelength. Light source 21 is, for example, a light source that emits a coherent sub-terahertz wave.

For example, one of two light sources 21 emits a sub-terahertz wave toward one of two reflectors 22. The other of two light sources 21 emits a sub-terahertz wave toward the other of two reflectors 22. One of light sources 21 is located, for example, on the surface 22a side of one of reflectors 22 and on the first direction side of one of reflectors 22. In imaging apparatus 10, the first direction is the direction in which pathway 101 extends and person 100 travels. The first direction is, for example, parallel to the direction in which reflectors 22 extend in a top view (in other words, vertical to the thickness direction of reflectors 22). The other of light sources 21 is located, for example, on the surface 22a side of the other of reflectors 22 and on the first direction side of the other of reflectors 22. Light sources 21 and reflectors 22 are disposed, for example, spaced apart from each other. Light sources 21 are disposed, for example, closer to reflectors 22 than detection device 30. The number of light sources 21 included in emitter 20 is not limited to two, and thus may be one, three, or more.

Each of light sources 21 is, for example, a point light source that emits a sub-terahertz wave to the surroundings of light source 21. Light source 21 may also be a line light source that extends along the edge of reflector 22 in the first direction and emits a sub-terahertz wave. Each of light sources 21 is realized, for example, by means of a light source including a known sub-terahertz wave generating element.

Reflectors 22 cover the space above pathway 101 that person 100 passes through, specifically imaging space 102, from at least one of both sides of pathway 101. “Covering the space from at least one of both sides of pathway 101” means covering the space from at least one of both side directions that are two directions perpendicular to the extending direction of pathway 101 when pathway 101 is viewed from above. In the present embodiment, imaging space 102 above pathway 101 that person 100 passes through is interposed between reflectors 22 from both sides of pathway 101. That is to say, reflectors 22 cover imaging space 102 from both sides of pathway 101. Imaging space 102 is, for example, a space interposed between inner surfaces 22a of two reflectors 22, of the space above pathway 101.

In the present embodiment, two reflectors 22 stand on the floor surface on both sides of pathway 101 to face each other. Stated differently, two reflectors 22 are disposed to have pathway 101 interposed therebetween in a top view. In the illustrated example, two reflectors 22 are disposed to be parallel to each other. In the illustrated example, two reflectors 22 each stand perpendicularly to the floor surface on which pathway 101 is provided. Note that imaging apparatus 10 is only required to include at least one reflector 22, and thus may include only one of two reflectors 22. Imaging apparatus 10 may further include, for example, a reflector other than two reflectors 22 shown in the diagram, such as a reflector located above two reflectors 22. Reflectors 22 may be a tunnel-shaped reflector that stands from the floor surface.

Each of two reflectors 22 is in a plate shape. Each of two reflectors 22 has surface 22a that serves as the front surface when reflector 22 is viewed from the thickness direction of reflector 22. Two reflectors 22 are disposed in a manner that surface 22a of one of two reflectors 22 and surface 22a of the other of two reflectors 22 face each other. Stated differently, each surface 22a is a surface on the imaging space 102 side of reflector 22. Non-limiting examples of the shape of each of reflectors 22 in a plan view include a rectangular shape.

Each of reflectors 22 diffusely reflects a sub-terahertz wave emitted from light source 21. More specifically, reflector 22 diffusely reflects, at surface 22a, a sub-terahertz wave that enters from the imaging space 102 side. For this reason, each of surfaces 22a is a surface from which a sub-terahertz wave is emitted, and each of reflectors 22 serves as a surface light source.

In each of reflectors 22, surface 22a is an uneven surface that diffusely reflects a sub-terahertz wave. For example, the average length of roughness curve element RSm of surface 22a is greater than or equal to the wavelength of a sub-terahertz wave emitted from light source 21. The average length of roughness curve element RSm of surface 22a may be, for example, between 0.15 mm and 0.3 mm, inclusive. With this, the sub-terahertz wave is diffusely reflected by surface 22a in an efficient manner.

Each of reflectors 22 includes, for example, a metal or a conductive member such as a conductive oxide, at least in a portion including surface 22a. Note that each of reflectors 22 may include a protective member covering surface 22a. The protective member is formed of, for example, a resin that transmits a sub-terahertz wave.

As shown in FIG. 4, the sub-terahertz wave emitted from light source 21 is diffusely reflected one or more times by at least one of two reflectors 22, and person 100 is irradiated with the diffusely-reflected sub-terahertz wave. As described, since imaging space 102 is interposed between reflectors 22 that diffusely reflect sub-terahertz waves, a sub-terahertz wave that has entered imaging space 102 is likely to remain in imaging space 102, and person 100 is irradiated with the sub-terahertz wave from various angles.

Since the sub-terahertz wave emitted from light source 21 is diffusely reflected one or more times by reflector 22 and then emitted to person 100, a distribution occurs in the optical path length, through which the sub-terahertz wave emitted from light sources 21 travels to be emitted to person 100. Such distribution of the optical path length results in the distribution of the phases of the sub-terahertz wave incident on person 100. As result, the angular distribution of the phases of the reflected wave from person 100 also occurs. For this reason, when the foregoing emitter 20 is used, an image of the reflected wave is likely to include uneven brightness, as described with reference to FIG. 1. Imaging apparatus 10 according to the present embodiment is capable of controlling such uneven brightness in an image.

### [Detection Device]

Detection device 30 generates an image, on the basis of the reflected wave of the sub-terahertz wave emitted from emitter 20 and reflected by person 100. Generating an image is also referred to as “imaging/capturing an image”. Stated differently, detection device 30 of imaging apparatus 10 captures an image of person 100 in imaging space 102. Detection device 30 outputs the image generated to image processor 90. Detection device 30 includes image sensor 31 and optical system 32. Detection device 30 is disposed in a position at which detection device 30 is able to receive the reflected wave from person 100. For example, detection device 30 is located on the first direction side of reflector 22.

Image sensor 31 receives the reflected wave from person 100, which is the sub-terahertz wave emitted from light source 21 and then diffusely reflected by reflector 22. Image sensor 31 detects the intensity of the reflected wave received, and generates an image, on the basis of the intensity detected. More specifically, image sensor 31 includes a plurality of pixels that are disposed in a planar arrangement and each receive the reflected wave imaged by optical system 32. Image sensor 31 generates an image on the basis of: signals corresponding to cumulative intensities, each being obtained by accumulating the intensity of the reflected wave received by each of the plurality of pixels for a predetermined time; and the planar arrangement of the plurality of pixels. The predetermined time is, for example, the duration of the exposure period in one frame, but may be the sum of the durations of the exposure periods in a plurality of frames. For example, image sensor 31 converts images of the reflected wave from person 100 into electric signals corresponding to the cumulative intensities. Image sensor 31 then generates an image that is based on the converted electric signals. The image generated by image sensor 31 is outputted to image processor 90. Image sensor 31 also includes control circuit 31a that controls each circuit included in image sensor 31. The configuration of image sensor 31 is described in detail later.

Optical system 32 images, onto image sensor, 31 the reflected wave of the sub-terahertz wave emitted from emitter 20 and reflected by person 100. Optical system 32 includes, for example, at least one lens or mirror.

In the present embodiment, for example, image sensor 31 allows for the setting of a longer time as the predetermined time during which the intensity of the received reflected wave is accumulated than that of a conventional image sensor that generates an image of a sub-terahertz wave. The predetermined time may be, for example, λ/1778 seconds or longer and λ/254 seconds or longer, when the wavelength of the sub-terahertz wave emitted by emitter 20 is taken as A mm. With this, the angular distribution of the phases of the reflected wave to be received by image sensor 31 changes by a predetermined amount or more during the predetermined time, in response to the travel of person 100 in imaging space 102. It is thus possible to control uneven brightness in the resulting image. From the viewpoint of controlling image blurring, the predetermined time may also be λ/10 seconds or less, or λ/30 seconds or less.

The following describes the configuration of image sensor 31 that allows for the setting of a longer time as the predetermined time during which the intensity of the received reflected wave is accumulated.

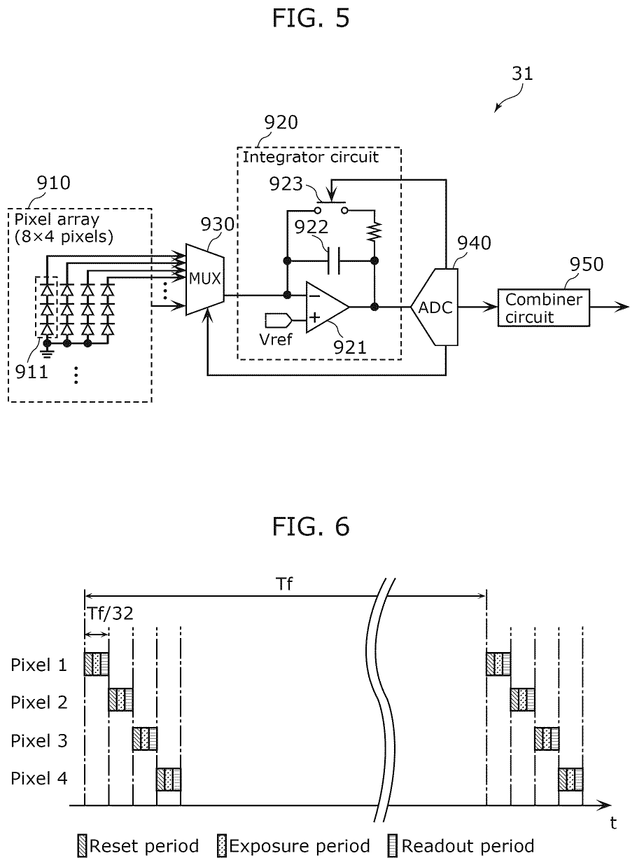

FIG. 5 is a diagram showing an example of the circuit configuration of image sensor 31 according to the present embodiment. As shown in FIG. 5, image sensor 31 includes pixel array 910, integrator circuit 920, multiplexer 930, analog-to-digital converter 940, and combiner circuit 950.

Pixel array 910 includes a plurality of pixels 911 that are deposed in a planar arrangement. Pixel array 910 forms a receiving surface on which the reflected wave is imaged. In an example shown in FIG. 5, the plurality of pixels 911 are arranged in an array of eight rows by four columns. In FIG. 5, four of thirty-two pixels 911 are illustrated as representative pixels. In the following, an example is described in which thirty-two pixels 911 are included in pixel array 910, but the number of the plurality of pixels 911 is not limited to a specific number.

Each of the plurality of pixels 911 includes a conversion element such as a diode that converts the received sub-terahertz wave into electric charge. Each of the plurality of pixels 911 generates an amount of electric charge that corresponds to the intensity of the received sub-terahertz wave (more specifically, the reflected wave from person 100). The plurality of pixels 911 is not limited to having a configuration that includes diodes, and thus any configurations may be used that include conversion elements, each being capable of converting the received sub-terahertz wave into an electric signal.

Integrator circuit 920 is a circuit that integrates inputs from the plurality of pixels 911 during the exposure period. Integrator circuit 920 is connected to each of the plurality of pixels 911 via multiplexer 930. The electric charge (voltage) generated by each of the plurality of pixels 911 is inputted to integrator circuit 920.

Integrator circuit 920 includes operational amplifier 921, capacitive element 922, and switch 923.

The inverting input terminal of operational amplifier 921 is connected to the plurality of pixels 911 via multiplexer 930. The non-inverting input terminal of operational amplifier 921 is connected to reference voltage Vref. The output of operational amplifier 921 is connected to analog-to-digital converter 940.

One end of capacitive element 922 is connected between the inverting input terminal of operational amplifier 921 and multiplexer 930. The other end of capacitive element 922 is connected between the output of operational amplifier 921 and analog-to-digital converter 940.

One end of switch 923 is connected between the inverting input terminal of operational amplifier 921 and multiplexer 930. The other end of switch 923 is connected between the output of operational amplifier 921 and analog-to-digital converter 940 via a resistor. Switch 923 is connected in parallel with capacitive element 922.

In integrator circuit 920, the electric charge from each of the plurality of pixels 911 is accumulated in capacitive element 922 (i.e., the voltage is integrated) during the period in which switch 923 is OFF, and the voltage corresponding to the electric charges accumulated by operational amplifier 921 are outputted. Also, when switch 923 is turned ON, the electric charges accumulated in capacitance element 922 are discharged.

Multiplexer 930 selects the output of one pixel 911, among the outputs of the plurality of pixels 911, on the basis of a selection signal, and outputs the selected output to integrator circuit 920.

Analog-to-digital converter 940 converts the output from integrator circuit 920 from analog to digital (AD conversion), and outputs the resultant to the circuit at the subsequent stage. Analog-to-digital converter 940 also outputs a signal for synchronizing the ON/OFF operation of switch 923 and the selection of pixel 911 to be read out.

Combiner circuit 950 combines the signals of the plurality of pixels 911 obtained in a plurality of frames. For example, combiner circuit 950 receives digital signals (pixel values) obtained through AD conversation performed by analog-to-digital converter 940, holds the received digital signals in, for example, memory, and adding up or averages the signals of the plurality of pixels 911 in the plurality of frames. In an example shown in FIG. 5, combiner circuit 950 is provided at the subsequent stage of analog-to-digital converter 940, but may be provided at the preceding stage of analog-to-digital converter 940. For example, combiner circuit 950 may be a circuit that includes, for example, a multiplexer and a capacitive element, and holds and accumulates the analog signals (voltages) of the plurality of pixels 911 over the plurality of frames before being subjected to AD conversion. The analog signals accumulated by combiner circuit 950 may then be AD converted.

Although not shown in FIG. 5, the operation of at least one of pixel array 910, integrator circuit 920, multiplexer 930, analog-to-digital converter 940, or combiner circuit 950 is controlled by, for example, control circuit 31a described above. Control circuit 31a may also have a function of modulating a clock that determines the exposure periods (frame lengths) of the plurality of pixels 911.

Next, an example of the operation performed by image sensor 31 shown in FIG. 5 is described. FIG. 6 is a timing chart for explaining the operation performed by image sensor 31 shown in FIG. 5. In FIG. 6, timings at which the operation of reading out the signals of representative four pixels 911 among the plurality of pixels 911 are shown in the rows indicated as Pixel 1 through Pixel 4.

As shown in FIG. 6, the reset operation that is performed before integrating the signal of pixel 1 is first performed during the reset period. More specifically, the reset operation is performed by capacitive element 922 discharging the electric charge, in response to the turning ON of switch 923, and multiplexer 930 selecting the input of pixel 1.

Next, the exposure period of pixel 1 starts in response to the turning OFF of switch 923. During the period in which switch 923 is OFF, the electric charge from pixel 1 is accumulated in capacitive element 922, and the input (voltage) of pixel 1 is integrated. Stated differently, the intensity of the reflected wave from person 100 is accumulated.

Next, during the readout period after the end of the exposure period of pixel 1, the integrated voltage is read out from integrator circuit 920. More specifically, the integrated voltage is inputted to analog-to-digital converter 940, subjected to AD conversion, and outputted to the circuit at the subsequent stage. As a result, a digital signal (pixel value) corresponding to the intensity of the reflected wave received by pixel 1 integrated during the exposure period of pixel 1 is outputted.

After the readout period of pixel 1 ends, the reset period of pixel 2 starts, and the same operation as that for pixel 1 is performed for pixel 2, from the reset to the reading out of the signal. Such operation is performed sequentially for pixel 3 and pixel 4, and for other pixels 911, to complete one frame period Tf, and the pixel value of each of the plurality of pixels 911 is outputted.

In image sensor 31 shown in FIG. 5, one integrator circuit 920 is connected to thirty-two pixels 911. As such, as is known from FIG. 6, the exposure periods for other pixels 911 cannot be set during the exposure period of one pixel 911. As a result, the exposure period of one pixel 911 is Tf/32 or less. For this reason, when image sensor 31 does not include combiner circuit 950, an image is generated on the basis of the signals corresponding to the cumulative intensities obtained by accumulating the intensity of the reflected wave for only a very short period of time. In contrast, image sensor 31 that includes combiner circuit 950 enables an image to be generated by combining the signals in the exposure periods of the plurality of frames, thus increasing the predetermined time during which the intensity is accumulated. Stated differently, the predetermined time during which the intensity is accumulated is the time obtained by multiplying the duration of the exposure period by the number of frames whose signals are combined.

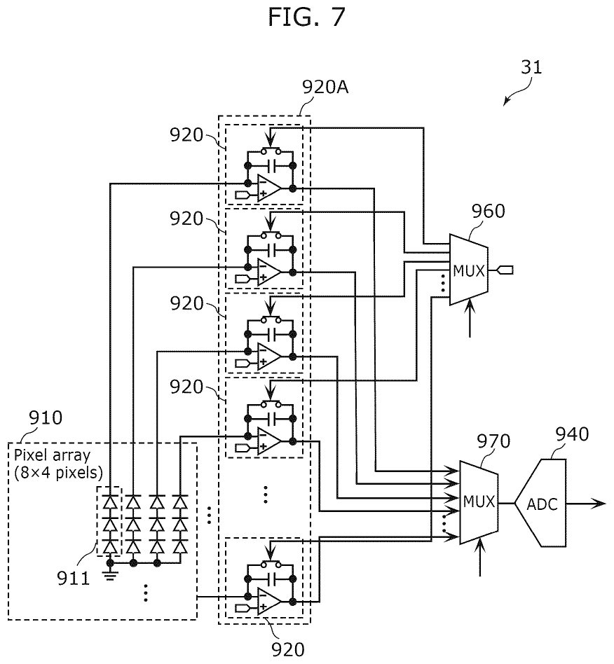

Next, another circuit configuration of image sensor 31 is described. FIG. 7 is a diagram showing another example of the circuit configuration of image sensor 31 according to the present embodiment. In the following, the descriptions of the same elements as those in FIG. 5 may be omitted or simplified.

As shown in FIG. 7, image sensor 31 includes pixel array 910, integrator circuit group 920A, analog-to-digital converter 940, multiplexer 960, and multiplexer 970.

Integrator circuit group 920A includes a plurality of integrator circuits 920. FIG. 7 shows the plurality of integrator circuits 920 arranged vertically in a row in integrator circuit group 920A, but the plurality of integrator circuits 920 are not limited to being disposed in a specific manner. The plurality of integrator circuits 920 are not required to be arranged in a row, and thus may be arranged in a dispersed manner.

In integrator circuit group 920A, the plurality of integrator circuits 920 are connected one-to-one to the plurality of pixels 911. Stated differently, one integrator circuit 920 is connected to one pixel 911. For this reason, in the present example, there is no need for multiplexer 930 that is provided between pixels 911 and integrator circuit 920, as in an example shown in FIG. 5. Note that the plurality of integrator circuits 920 are not required to be connected one-to-one to the plurality of pixels 911, and thus one integrator circuit 920 may be connected to two or more pixels 911 via the multiplexer.

Multiplexer 960 is connected to the control line of switch 923 of each of the plurality of integrator circuits 920. Multiplexer 960 selects one integrator circuit 920, among the plurality of integrator circuits 920, and outputs a signal for controlling ON/OFF of switch 923, on the basis of the selection signal.

Multiplexer 970 is connected to the output of each of the plurality of integrator circuits 920 (output terminal of operational amplifier 921). Multiplexer 970 selects the output of one integrator circuit 920, among the outputs of the plurality of integrator circuits 920, on the basis of the selection signal, and outputs the selected output to analog-to-digital converter 940.

Although not shown in FIG. 7, the operation of at least one of pixel array 910, integrator circuit group 920A, analog-to-digital converter 940, multiplexer 960, or multiplexer 970 is controlled by, for example, control circuit 31a described above. Control circuit 31a may also have a function of modulating a clock that determines the exposure periods (frame lengths) of the plurality of pixels 911.

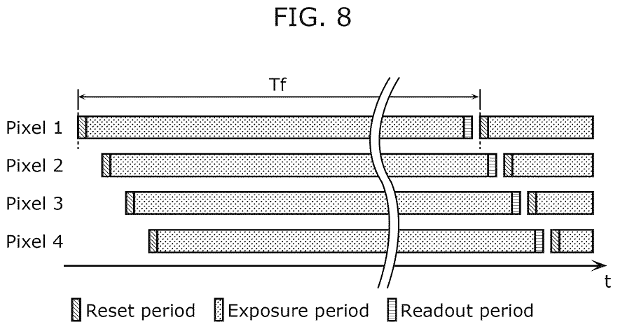

Next, an example of the operation performed by image sensor 31 shown in FIG. 7 is described. FIG. 8 is a timing chart for explaining the operation performed by image sensor 31 shown in FIG. 7. In FIG. 8, timings at which the operation for reading out the signals of representative four pixels 911 among the plurality of pixels 911 are shown in the form of rows indicated as Pixel 1 through Pixel 4.

As shown in FIG. 8, the reset operation that is performed before integrating the signal of pixel 1 is first performed during the reset period. Here, switch 923 of integrator circuit 920 corresponding to pixel 1 is turned ON in response to the selection by multiplexer 960.

Next, the exposure period of pixel 1 starts in response to the turning OFF of switch 923 of integrator circuit 920 corresponding to pixel 1.

Next, during the exposure period of pixel 1, the reset operation of pixel 2 is performed during the reset period, and the exposure period of pixel 2 further starts. At this time, switch 923 of integrator circuit 920 corresponding to pixel 2 is controlled in accordance with the selection by multiplexer 960. As described above, the exposure period of pixel 1 overlaps the reset period and the exposure period of pixel 2.

Next, as with pixel 2, the reset operation is performed for pixel 3 and pixel 4, and further for other pixels 911 during the exposure period of pixel 1, and the exposure periods start.

After the exposure periods of all of the plurality of pixels 911 start, the exposure period of pixel 1 ends, and in the readout period, multiplexer 970 selects integrator circuit 920 corresponding to pixel 1, and the integrated voltage is read out from integrator circuit 920 corresponding to pixel 1. More specifically, the integrated voltage is inputted to analog-to-digital converter 940, subjected to AD conversion, and outputted to the circuit at the subsequent stage. As a result, a digital signal (pixel value) corresponding to the intensity of the reflected wave received by pixel 1 integrated during the exposure period of pixel 1 is outputted. Here, the readout period of pixel 1 overlaps the exposure periods of pixels 911 other than pixel 1.

After the readout period of pixel 1 ends, the same readout operation as for pixel 1 is sequentially performed for the plurality of pixels 911 other than pixel 1. As a result, the pixel value of each of the plurality of pixels 911 is obtained, and an image is generated on the basis of: the signals corresponding to the cumulative intensities, each being obtained by accumulating the intensity of the reflected wave received by each of the plurality of pixels 911 for the predetermined time; and the planar arrangement of the plurality of pixels 911.

As shown in FIG. 8, in the present example, image sensor 31 includes the plurality of integrator circuits 920, thereby enabling the exposure periods of the plurality of pixels 911 to overlap. This increases the proportion of the exposure periods in frame period Tf in the plurality of pixels 911. In the present example, the predetermined time during which image sensor 31 accumulates the intensity of the reflected wave is the duration of the exposure period in one frame. Since image sensor 31 in an example shown in FIG. 7 is capable of securing a long exposure period compared to image sensor 31 in an example shown in FIG. 5, it is possible to increase the predetermined time during which the intensity is accumulated in one frame period Tf. This thus shortens the time required for image generation. Also, since the intensity of the reflected wave is accumulated over consecutive periods, it is possible to control blurring in the resulting image.

Note that image sensor 31 shown in FIG. 7 may further include combiner circuit 950 shown in FIG. 5.

### [Controller]

With reference to FIG. 3 and FIG. 4 again, controller 40 is a control device that controls an operation performed in imaging apparatus 10. For example, controller 40 controls the operation of at least one of emitter 20, detection device 30, phase modulator 50, detector 60, alarm 70, conveyer 80, or display 95 as the control of ab operation performed in imaging apparatus 10. Controller 40 also controls an operation performed in imaging apparatus 10 on the basis of, for example, the traveling state of person 100 detected by detector 60, when such person 100 passes through imaging space 102. The control of the operation performed by controller 40 is described in detail later.

Controller 40 includes, for example, a processor and memory, and is realized by means of the processor executing a program stored in the memory.

### [Phase Modulator]

Phase modulator 50 changes the angular distribution of the phases of the reflected wave to be received by image sensor 31 during the exposure period in which image sensor 31 is generating an image. In the present embodiment, phase modulator 50 changes the phase of at least some components of the reflected wave that is the sub-terahertz wave emitted from emitter 20 and reflected by person 100, before such reflected wave enters image sensor 31, thereby changing the angular distribution of the phases of the reflected wave to be received by image sensor 31. Phase modulator 50 may also change the angular distribution of the phases of the reflected wave to be received by image sensor 31 by changing the phase of the sub-terahertz wave emitted to person 100. An example of phase modulator 50 changing the phase of the sub-terahertz wave emitted to person 100 is described later.

Phase modulator 50 operates, for example, on the basis of the control performed by controller 40, but may be constantly in operation while imaging apparatus 10 is capturing an image.

Phase modulator 50 includes phase difference plate 51 and driver 52. Driver 52 is an example of the phase difference plate driver.

Phase difference plate 51 is a plate-shaped member having the property of transmitting a sub-terahertz wave. Phase difference plate 51 changes the phase of the sub-terahertz wave transmits therethrough. In phase difference plate 51, the amount of phase change to a sub-terahertz wave that transmits therethrough differs depending on the position from which the sub-terahertz wave transmits phase difference plate 51. In the present embodiment, a sub-terahertz wave that transmits through phase difference plate 51 is the reflected wave of the sub-terahertz wave emitted from emitter 20 and reflected by person 100. When phase difference plate 51 is moved by driver 52, the amount of phase change to the sub-terahertz wave that transmits through phase difference plate 51 changes depending on position and time.

For example, phase difference plate 51 transmits 50% or more of the sub-terahertz wave that enters from the thickness direction of phase difference plate 51. Phase difference plate 51 may transmit 80% or more, or 90% or more of the sub-terahertz wave that enters from the thickness direction of phase difference plate 51.

Phase difference plate 51 is disposed on the optical path of the reflected wave from person 100 that enters image sensor 31, between imaging space 102 and image sensor 31. In an example shown in FIG. 4, phase difference plate 51 is disposed between imaging space 102 and optical system 32, but may also be disposed between optical system 32 and image sensor 31.

Used as a material of phase difference plate 51 is a dielectric material such as a resin material having the property of transmitting a sub-terahertz wave. Examples of the resin material include polycarbonate resin, acrylic resin, epoxy resin, silicone resin, polystyrene resin, polyethylene resin, polypropylene resin, fluorine resin, etc.

Driver 52 is a driving device that moves phase difference plate 51 under a predetermined condition, thereby changing the angular distribution of the phases of the reflected wave to be received by image sensor 31. For example, driver 52 moves phase difference plate 51 to change the amount of phase change to a sub-terahertz wave that transmits through phase difference plate 51 during the exposure period of image sensor 31. Driver 52 includes, for example, a driving machine such as a motor and an actuator, and a power transmission member such as a belt, a gear, a pulley, and a connecting shaft for transmitting power to phase difference plate 51.

Here, phase difference plate 51 is described in detail, using specific examples.

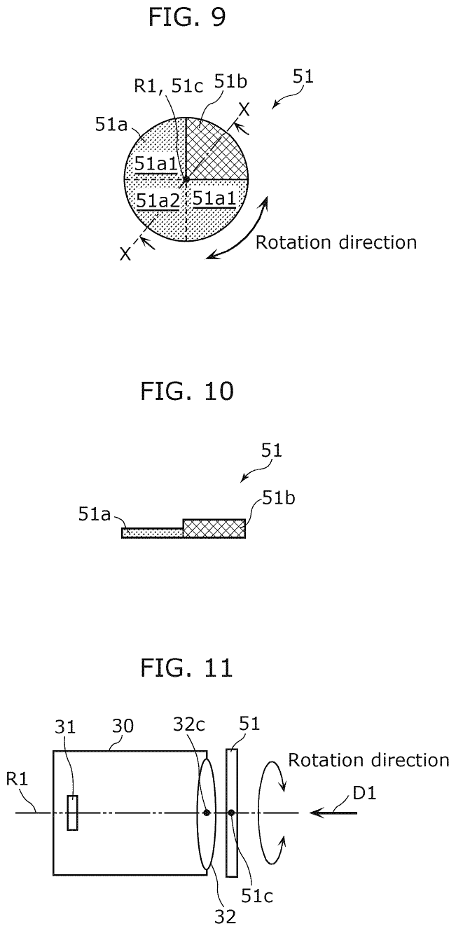

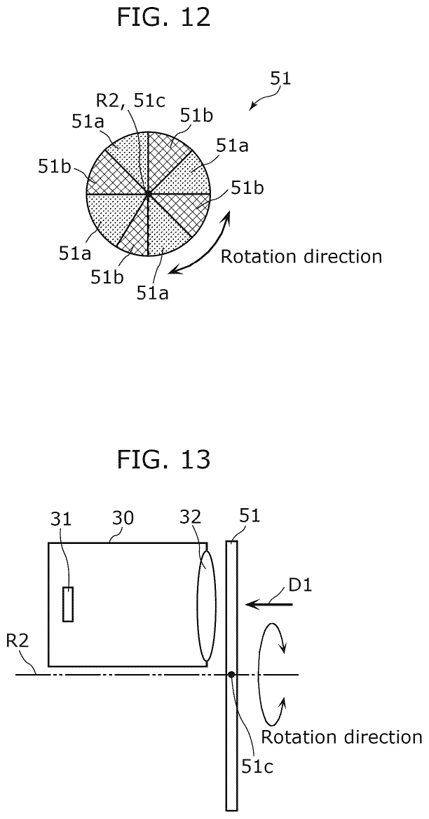

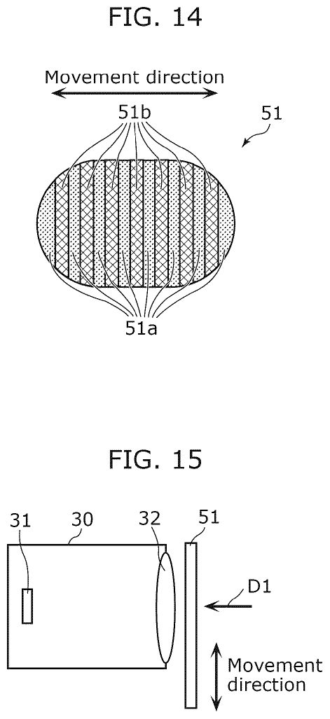

FIG. 9 is a plan view showing one example of phase difference plate 51 according to the present embodiment. FIG. 10 is a cross-sectional view showing one example of phase difference plate 51 according to the present embodiment. FIG. 10 shows a cross-section along the X-X line in FIG. 9. FIG. 11 is a schematic diagram for explaining an example of the movement of one example of phase difference plate 51 according to the present embodiment. In FIG. 9 and FIG. 10, each region is marked with a different pattern to distinguish between first region 51a and second region 51b. This is also applicable to FIG. 12 and FIG. 14 to be described later.

As shown in FIG. 9 and FIG. 10, phase difference plate 51 includes first region 51a and second region 51b. Each of first region 51a and second region 51b has the property of transmitting a sub-terahertz wave. The amount of phase change to a sub-terahertz wave that transmits through first region 51a and the amount of phase change to a sub-terahertz wave that transmits through second region 51b are different. More specifically, the difference in the thickness between first region 51a and second region 51b results in a difference in the amount of phase change to the sub-terahertz wave that transmits therethrough. In the present embodiment, the sub-terahertz wave that transmits through first region 51a and second region 51b is the reflected wave from person 100. In an example shown in the diagram, the thickness of first region 51a is smaller than the thickness of second region 51b, but the thickness of first region 51a may be greater than the thickness of second region 51b.

For example, by setting the thicknesses of first region 51a and second region 51b in accordance with the refractive index of the material used for phase difference plate 51, it is possible to set a desired amount of phase change to the sub-terahertz wave. Note that the amount of phase change to the sub-terahertz wave that transmits through phase difference plate 51 may be made different by changing the refractive index of the material used for each of first region 51a and second region 51b. In this case, the thickness of first region 51a and the thickness of second region 51b may be the same.

The difference between the amount of phase change to the sub-terahertz wave that transmits through first region 51a and the amount of phase change to the sub-terahertz wave that transmits through second region 51b is, for example, between ¼ and ¾, inclusive (i.e., between 90° and 270°, inclusive), of the wavelength of a sub-terahertz wave used in imaging apparatus 10, and thus may be ½ (i.e., 180°) of the wavelength of a sub-terahertz wave used in imaging apparatus 10. This effectively changes the angular distribution of the phases of the reflected wave to be received by image sensor 31, thereby controlling uneven brightness caused by interference. Note that phase difference plate 51 may further include another region in which the amount of phase change to a sub-terahertz wave that transmits therethrough differs from those of first region 51a and second region 51b.

As shown in FIG. 11, phase difference plate 51 is rotated by driver 52, for example, about rotation axis R1, which passes through center 32c of optical system 32 and has an inclination angle between −10° and 10°, inclusive, with respect to the direction parallel to incident direction D1 in which the reflected wave enters optical system 32. Here, rotation axis R1 is a virtual axis line, which means that a substantive axis body is not necessarily present. The same is applicable to the rotation axes to be described later. Also, incident direction D1 in which the reflected wave enters optical system 32 is, for example, the direction connecting the focal point of optical system 32 and center 32c of optical system 32 (in other words, the optical axis direction of optical system 32). For example, phase difference plate 51 is moved, using, as driver 52, a motor attached with a pulley and connecting the pulley and phase difference plate 51 with a belt. Phase difference plate 51 rotates, for example, at least once during the exposure period of image sensor 31. The rotation speed of phase difference plate 51 is not limited to a specific speed, and thus may be any speeds at which phase difference plate 51 can be rotated by driver 52. Also, as shown in FIG. 9 and FIG. 11, rotation axis R1 is, for example, parallel to the thickness direction of phase difference plate 51 and passes through center 51c of phase difference plate 51 in a plan view. As described above, by disposing phase difference plate 51 such that phase difference plate 51 rotates about rotation axis R1 that passes through center 32c of optical system 32, it is possible to compactly dispose phase difference plate 51 to be moved. Note that rotation axis R1 does not have to pass through center 51c of phase difference plate 51. Also, rotation axis R1 may pass through a position other than center 32c of optical system 32. Rotation axis R1 may not be parallel to the thickness direction of phase difference plate 51, and may be inclined with respect to the thickness direction (e.g., inclined at an inclination angle between −10° and 10°, inclusive).

As shown in FIG. 9, the shape of phase difference plate 51 is, for example, a circular shape in a plan view, but the shape of phase difference plate 51 in a plan view is not limited to a specific shape. In the present specification, “plan view” means a view of phase difference plate 51 seen in the thickness direction of phase difference plate 51. First region 51a and second region 51b are disposed to lie in the rotation direction of phase difference plate 51 in a plan view. In the present example, the shape of each of first region 51a and second region 51b is, for example, a fan shape, with center 51c of phase difference plate 51 serving as the apex, and first region 51a and second region 51b are arranged in the arc direction. In an example shown in FIG. 9, phase difference plate 51 includes one first region 51a and one second region 51b, but may include a plurality of first regions 51a and a plurality of second regions 51b. In this case, first region 51a and second region 51b are arranged, for example, alternately in the rotation direction of difference plate 51.

Also, the area of first region 51a is larger than the area of second region 51b in a plan view. When a plurality of first regions 51a and a plurality of second regions 51b are present, the area of first region 51a and the area of second region 51b are each the total area of the plurality of regions.

First region 51a includes symmetric region 51a1 having point symmetry across rotation axis R1 in a plan view, and asymmetric region 51a2 positioned to have point symmetry with second region 51b across rotation axis R1 in a plan view. With this, at a certain point in time, the components of the reflected wave passing through two points that are positioned to have point symmetry across rotation axis R1 both pass through symmetric region 51a1. As a result, the phases of the components of the reflected wave passing through the certain two points change in the same manner. In contrast, at a point in time that is different from the foregoing certain point in time, the components of the reflected wave passing through certain two points pass through asymmetric region 51a2 and second region 51b as a result of the rotation of phase difference plate 51. As a result, the amounts of phase change to the components of the reflected wave passing through the certain two points are different. For this reason, the rotation of phase difference plate 51 effectively changes the angular distribution of the phases of the reflected wave to be received by image sensor 31 during the exposure period of image sensor 31. This makes it easier to control uneven brightness in the image.

In a plan view, the area of asymmetric region 51a2 is, for example, between ⅛ and ⅜, inclusive, of the area of phase difference plate 51, and thus may be ¼ of the area of phase difference plate 51. Also, in a plan view, the area of symmetric region 51a1 may be, for example, between ⅜ and ⅝, inclusive, of the area of phase difference plate 51, and thus may be ½ of the area of phase difference plate 51. With this, the difference between the times at which the amount of phase change to the components of the reflected wave passing through the foregoing two points are the same and different, thereby more effectively changing the angular distribution of the phases of the reflected wave to be received by image sensor 31.

Note that phase difference plate 51 is not limited to a specific member, and thus may be any members capable of changing the phase of a sub-terahertz wave that transmits therethrough. Here, another example of phase difference plate 51 is described. FIG. 12 is a plan view showing another example of phase difference plate 51 according to the present embodiment. FIG. 13 is a schematic diagram for explaining an example of the movement of another example of phase difference plate 51 according to the present embodiment.

As shown in FIG. 12, in another example, phase difference plate 51 includes a plurality of first regions 51a and a plurality of second regions 51b. In the present example, phase difference plate 51 may include only one first region 51a and one second region 51b.

As shown in FIG. 13, phase difference plate 51 is rotated by driver 52, for example, about rotation axis R2, which does not pass through optical system 32 and has an inclination angle between −10° and 10°, inclusive, with respect to the direction parallel to incident direction D1 in which the reflected wave enters optical system 32. Phase difference plate 51 rotates, for example, at least once during the exposure period of image sensor 31. The rotation speed of phase difference plate 51 is not limited to a specific speed and thus may be any speeds at which phase difference plate 51 can be rotated by driver 52. Also, as shown in FIG. 12 and FIG. 13, rotation axis R2 is, for example, parallel to the thickness direction of phase difference plate 51 and passes through center 51c of phase difference plate 51 in a plan view. As described above, by disposing phase difference plate 51 such that phase difference plate 51 rotates about rotation axis R2 that does not pass through optical system 32, it is possible to rotate phase difference plate 51 simply by attaching an axis body to phase difference plate 51. This simplifies the configuration. Note that rotation axis R2 does not have to pass through center 51c of phase difference plate 51. Also, rotation axis R2 does not have to be parallel to the thickness direction of phase difference plate 51, and may be inclined with respect to the thickness direction (e.g., inclined at an angle between −10° and 10°, inclusive).

As shown in FIG. 12, in the present example, the shape of phase difference plate 51 is, for example, a circular shape in a plan view, but the shape of phase difference plate 51 in a plan view is not limited to a specific shape. As shown in FIG. 12, first region 51a and second region 51b are alternately arranged in the rotation direction of phase difference plate 51 in a plan view. In the present example, the shape of each of the plurality of first regions 51a and each of the plurality of second regions 51b is, for example, a fan shape, with center 51c of phase difference plate 51 serving as the apex, and first region 51a and second region 51b are alternately arranged in the arc direction. In a plan view, the area of each of the plurality of first regions 51a and the area of each of the plurality of second regions 51b is, for example, equal to each other. Note that at least one of the areas of the plurality of first regions 51a and at least one of the areas of the plurality of second regions 51b may be different in a plan view.

Next, still another example of phase difference plate 51 is described. FIG. 14 is a plan view showing still another example of phase difference plate 51 according to the present embodiment. FIG. 15 is a schematic diagram for explaining an example of the movement of still another example of phase difference plate 51 according to the present embodiment.

As shown in FIG. 14, in still another example, phase difference plate 51 includes a plurality of first regions 51a and a plurality of second regions 51b. The plurality of first regions 51a and the plurality of second regions 51b are disposed to lie in a predetermined direction. Note that in the present example, the number of at least one of first regions 51a or second regions 51b included in phase difference 51 may be one.

As shown in FIG. 15, phase difference plate 51 is moved, for example, by driver 52 in the direction orthogonal to incident direction D1 in which the reflected wave enters optical system 32 and the direction orthogonal to the thickness direction of phase difference plate 51. Phase difference plate 51 is moved, for example, back and forth at a predetermined frequency in the movement direction of phase difference plate 51. The predetermined frequency is, for example, a frequency whose period is less than or equal to the exposure period of image sensor 31. Also, the upper limit of the predetermined frequency is not limited to a specific limit, and thus may be any frequencies at which phase difference plate 51 can be moved back and forth by driver 52.

As shown in FIG. 14, in the present example, the shape of phase difference plate 51 in a plan view is, for example, an oval shape having a major axis and a minor axis, but the shape of phase difference plate 51 in a plan view is not limited to a specific shape. The shape of phase difference plate 51 in a plan view may be an ellipse shape or a rectangular shape having a major axis and a minor axis. The shape of phase difference plate 51 in a plan view may also be, for example, a circular shape, a square shape, a polygonal shape, etc. As shown in FIG. 14, in a plan view, first region 51a and second region 51b are alternately arranged in the movement direction of phase difference plate 51. For this reason, in the present example, the plurality of first regions 51a and the plurality of second regions 51b are each in stripes. Also, the movement direction is, for example, parallel to the long axis direction of phase difference plate 51. Phase difference plate 51 is moved in the movement direction such that the positions of first region 51a and second region 51b are switched at least at a predetermined position.

As described above, in the present embodiment, it is possible to change the amount of phase change to the reflected wave that transmits through phase difference plate 51 simply by rotating or moving back and forth phase difference plate 51 as in a manner described with reference to FIG. 9 through FIG. 15.

### [Detector]

With reference to FIG. 3 and FIG. 4 again, detector 60 is a sensor for detecting, for example, the traveling state of person 100 in imaging space 102. For example, detector 60 detects, as the traveling state of person 100, the traveling speed, etc. of person 100 when person 100 passes through the imaging space. Detector 60 may detect at least one of the presence, the position, or the posture of person 100 in imaging space 102. Detector 60 outputs the detection result to, for example, controller 40. In an example shown in FIG. 4, detector 60 is disposed on the first direction side of imaging space 102, but may be disposed at any positions at which detector 60 is able to detect the traveling state of person 100 in imaging space 102.

Detector 60 is, for example, a visible light camera that captures a moving image. Detector 60 may also have a function of distance measurement. Detector 60 captures a moving image, for example, thereby detecting at least one of the traveling speed, the presence, the position, or the posture of person 100 in imaging space 102. Detector 60 outputs, as the detection result, information relating to the traveling state. Detector 60 may output a moving image to controller 40 as the detection result, or may determine at least one of the traveling speed, the presence, the position, or the posture of person 100 from the moving image and output the determined result to controller 40 as the detection result. Detector 60 may also be, for example, another sensor such as a human sensor or a speed sensor. Also, the number of detectors 60 included in imaging apparatus 10 is one in an example shown in FIG. 4, but imaging apparatus 10 may include a plurality of detectors 60.

Note that imaging apparatus 10 may not include detector 60. Controller 40 may obtain a detection result relating to the traveling state of person 100 from an external device such as a surveillance camera.

Here, the detection of the traveling state performed by detector 60 is described in detail. In imaging apparatus 10, controller 40 determines whether the traveling state of person 100 is stationary, for example, on the basis of the traveling state of person 100 detected by detector 60. In the present specification, the expression “stationary” means not only that person 100 is in a completely still state, but also means a state including that the amount of travel of person 100 per unit time is small, such as a state in which the traveling speed of person 100 is less than a predetermined speed (e.g., less than the traveling speed of a typical person). Stated differently, in the present specification, “stationary” is an expression indicating that the amount of travel of person 100 during a predetermined time is less than a predetermined amount.

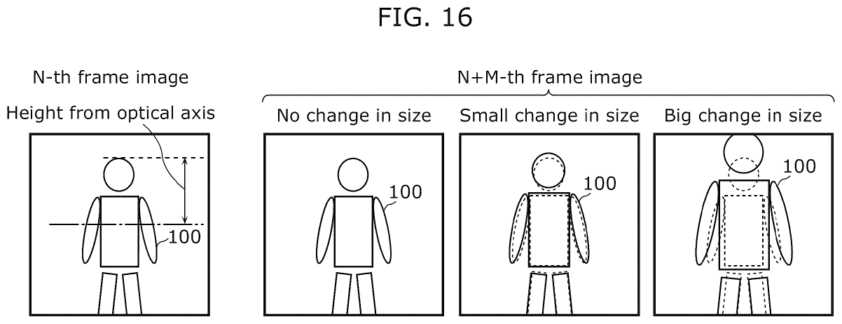

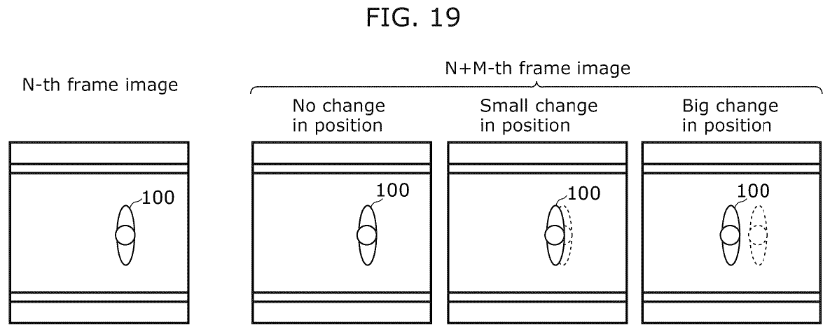

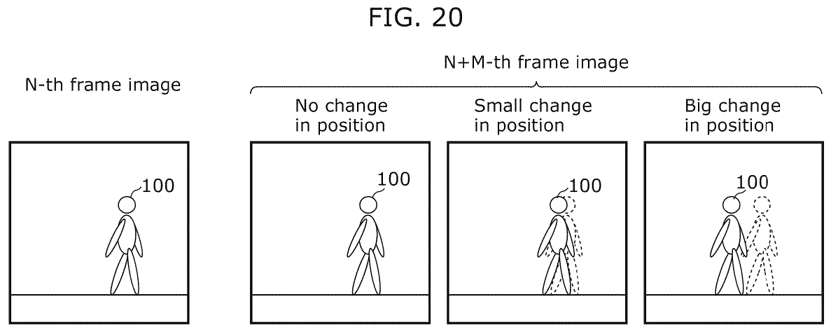

First, the case is described where detector 60 is a visible light camera disposed in the position shown in FIG. 4. FIG. 16 is a diagram showing examples of images outputted by detector 60. FIG. 16 shows an example of an N-th frame image and examples of an N+M-th frame image captured by detector 60, which is a visible light camera. Numerical value M is, for example, 1, but may be a natural number greater than or equal to 2. In FIG. 16, in the N+M-th frame images, person 100 shown in the N-th frame image is indicated by the dashed lines, but only person 100 in the solid lines is shown in the actual images. This is applicable to FIG. 19 and FIG. 20 to be described later.

As shown in FIG. 16, detector 60 outputs images as information indicating the detected traveling state. Controller 40 determines whether the traveling state is stationary, for example, on the basis of the traveling state detected by detector 60. In an example shown in FIG. 16, controller 40 determines whether the traveling state of person 100 is stationary, on the basis of the change in the size of person 100 in the image. Controller 40 compares the size of person 100 in the N-th frame image with the size of person 100 in the N+M-th frame image. Controller 40 determines that the traveling state is stationary when the change in the size of person 100 is less than a predetermined value, and determines that the traveling state is not stationary but a moving state when the change in the size of person 100 is greater than or equal to the predetermined value. The size of person 100 is, for example, the height of person 100 from the optical axis of optical system 32, but may also be other indicators such as the entire height or the width of person 100. More specifically, controller 40 determines that the traveling state is stationary, when, for example, the following criteria for determining the traveling state are satisfied: the change in the size of person 100 is less than 1.1% between the N-th frame image and the N+M-th frame image, when the frame rate of detector 60 is 20 fps, the imaging position (distance from detector 60 to person 100) is 4000 mm, the height of person 100 from the optical axis is 400 mm, and numerical value M=1.

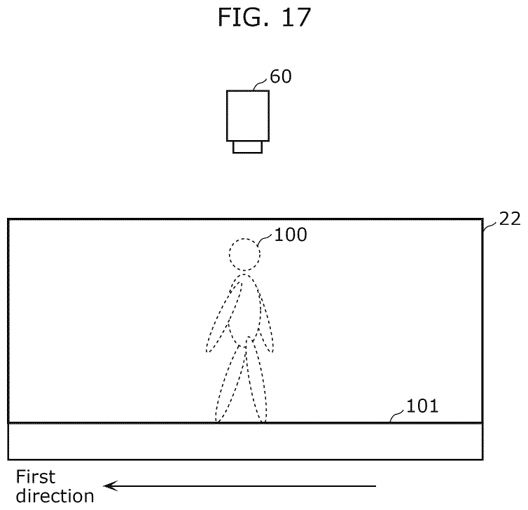

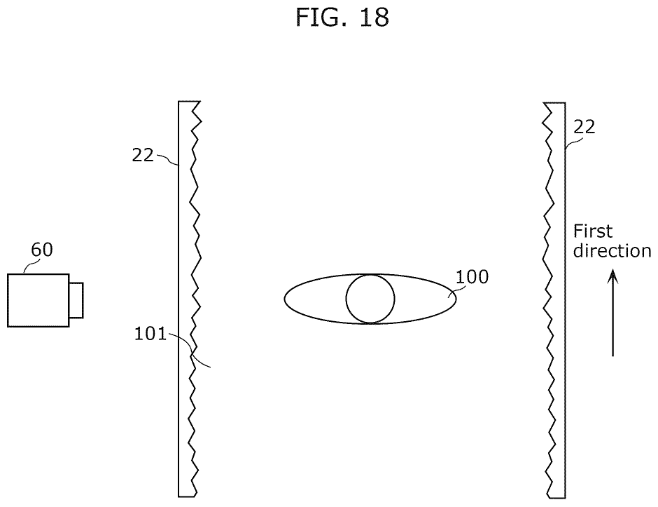

Next, the case is described where detector 60, which is a visible light camera, captures images of person 100 from the direction orthogonal to the first direction. FIG. 17 is a side view for explaining another example of the disposition of detector 60. FIG. 18 is a top view for explaining still another example of the disposition of detector 60. In FIG. 17 and FIG. 18, the illustration of the elements of imaging apparatus 10 other than reflectors 22 and detector 60 is omitted.

In an example shown in FIG. 17, detector 60 is disposed above reflectors 22. In an example shown in FIG. 18, detector 60 is disposed in the lateral side direction of reflector 22. In an example shown in FIG. 18, reflectors 22 are formed using a material such as a transmissive conductive oxide that transmits visible light and reflects a sub-terahertz wave. When disposed in the position as shown in FIG. 17 or FIG. 18, detector 60 is able to capture images of person 100 from the direction orthogonal to the first direction.

FIG. 19 is a diagram showing examples of images outputted by detector 60 shown in FIG. 17. FIG. 20 is a diagram showing examples of images outputted by detector 60 shown in FIG. 18. Each of FIG. 19 and FIG. 20 shows an example of an N-th frame image and examples of an N+M-th frame image captured by detector 60, which is a visible light camera. FIG. 19 shows images of person 100 captured by detector 60 at the position shown in FIG. 17. FIG. 20 shows images of person 100 captured by detector 60 at the position shown in FIG. 18.

In examples shown in FIG. 19 and FIG. 20, controller 40 determines whether the traveling state of person 100 is stationary, on the basis of the change in the position of person 100 in the image. Controller 40 compares the position of person 100 in the N-th frame image with the position of person 100 in the N+M-th frame image. Controller 40 determines that the traveling state is stationary when the change in the position of person 100 is less than a predetermined value, and determines that the traveling state is not stationary but a moving state when the change in the position of person 100 is greater than or equal to the predetermined value. More specifically, controller 40 determines that the traveling state is stationary when the following criteria for determining the traveling state are satisfied: the change in the position of person 100 is less than 44 mm between the N-th frame image and the N+M-th frame image, when the frame rate of detector 60 is 20 fps and numerical value M=1.

In the above description, controller 40 determines the traveling state of the person from two frames of images outputted by detector 60, but may also determine the traveling state from three or more frames of images.

Next, the cases are described where detector 60 is configured not in the form of a visible light camera, but as other sensors.

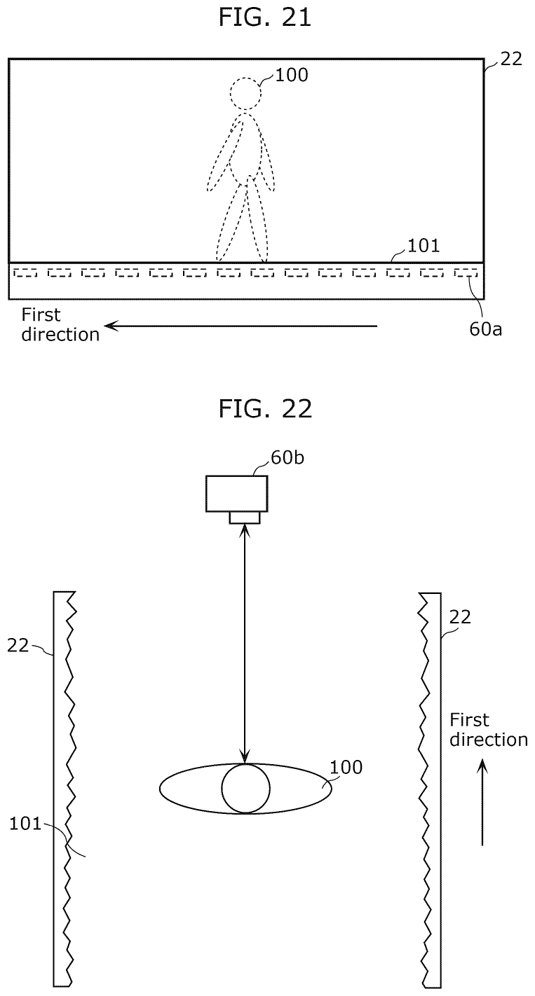

First, the case is described where the detector is configured in the form of a pressure sensor. FIG. 21 is a side view showing an example of the case where detector 60a according to the present embodiment is configured in the form of a pressure sensor. In FIG. 21, the illustration of the elements of imaging apparatus 10 other than reflectors 22 and detector 60a is omitted.

Imaging apparatus 10 may include detector 60a instead of detector 60. As shown in FIG. 21, detector 60a includes a plurality of pressure sensors, using, for example, piezoelectric elements. The plurality of pressure sensors are provided, for example, on the floor of pathway 101 and are arranged in the first direction. Detector 60a outputs the detection result of each of the plurality of pressure sensors at predetermined measurement intervals. In detector 60a, a pressure sensor at which the center of gravity of person 100 is located detects a high pressure. As such, the position of person 100 is determined on the basis of position of a pressure sensor that detects a high pressure. For this reason, detector 60a is capable of detecting the traveling state of person 100 by means of each of the plurality of pressure sensors detecting pressure at the predetermined measurement intervals. Note that detector 60a may be provided in conveyer 80.

Controller 40 determines whether the traveling state of person 100 is stationary, for example, on the basis of the change in the position of person 100 in the detection results of detector 60a. Controller 40 compares the detection result in an N-th measurement by detector 60a with the detection result in an N+M-th measurement by detector 60a. Numerical value M is, for example, 1, but may be a natural number greater than or equal to 2. Controller 40 determines that the traveling state is stationary when the change in the position of person 100 is less than a predetermined value, and determines that the traveling state is not stationary but a moving state when the change in the position of person 100 is greater than or equal to the predetermined value. More specifically, controller 40 determines that the traveling state is stationary when the following criteria for determining the traveling state are satisfied: the change in the position of person 100 is less than 8.9 mm between the detection result in the N-th measurement and the detection result in the N+M-th measurement, when the measurement interval of detector 60a is 0.1 seconds and numerical value M=1.

Next, the case is described where the detector is configured in the form of a distance sensor (distance-measuring device). FIG. 22 is a top view showing an example of the case where detector 60b according to the present embodiment is configured in the form of a distance sensor. In FIG. 22, the illustration of the elements of imaging apparatus 10 other than reflectors 22 and detector 60b is omitted.

Imaging apparatus 10 may include detector 60b instead of detector 60. As shown in FIG. 22, detector 60b is configured in the form of a distance sensor that measures the distance between detector 60b and person 100. Detector 60b is provided, for example, on the first direction side of reflector 22 (i.e., on the first direction side of imaging space 102). Detector 60b outputs the detection results of the distance sensor at predetermined measurement intervals. Detector 60b also determines the position of person 100 on the basis of the distance between detector 60b and person 100. For this reason, detector 60b is capable of detecting the traveling state of person 100 by means of the distance sensor detecting the distance between detector 60b and person 100 at the predetermined measurement intervals.

Controller 40 determines whether the traveling state of person 100 is stationary on the basis of the change in the position of person 100 in the detection results of detector 60b. Controller 40 compares the detection result in an N-th measurement by detector 60b with the detection result in an N+M-th measurement by detector 60b. Numerical value M is, for example, 1, but may be a natural number greater than or equal to 2. Controller 40 determines that the traveling state is stationary when the change in the position of person 100 is less than a predetermined value, and determines that the traveling state is not stationary but a moving state when the change in the position of person 100 is greater than or equal to the predetermined value. More specifically, controller 40 determines that the traveling state is stationary when the following criteria for determining the traveling state are satisfied: the change in the position of person 100 is less than 8.9 mm between the detection result in the N-th measurement and the detection result in the N+M-th measurement, when the measurement interval of detector 60b is 0.1 seconds and numerical value M=1.

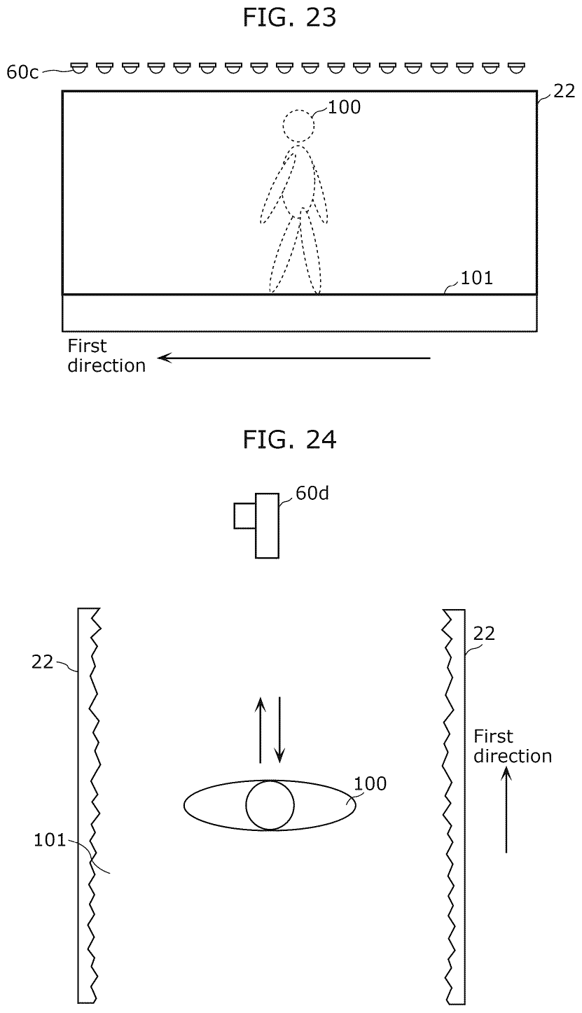

Next, the case is described where the detector is configured in the form of a human sensor. FIG. 23 is a side view showing an example of the case where detector 60c according to the present embodiment is configured in the form of a human sensor. In FIG. 23, the illustration of the elements of imaging apparatus 10 other than reflectors 22 and detector 60c is omitted.

Imaging apparatus 10 may include detector 60c instead of detector 60. As shown in FIG. 23, detector 60c is configured in the form of a plurality of human sensors that detect whether person 100 is present, using, for example, infrared rays. The plurality of human sensors are arranged, for example, in the first direction above reflector 22 (i.e., above imaging space 102). Each of the plurality of human sensors detects whether person 100 is present in a predetermined range below the human sensor. Detector 60c outputs the detection result of each of the plurality of human sensors at predetermined measurement intervals. Detector 60c detects the position of person 100 on the basis of the position of a human sensor that detects the presence of person 100. As such, detector 60c is capable of detecting the traveling state of person 100 by means of each of the plurality of human sensors detecting whether person 100 is present at the predetermined measurement intervals.

Controller 40 determines whether the traveling state of person 100 is stationary on the basis of the change in the position of person 100 in the detection results of detector 60c. Controller 40 compares the detection result in an N-th measurement by detector 60c with the detection result in an N+M-th measurement by detector 60c. Numerical value M is, for example, 1, but may be a natural number greater than or equal to 2. Controller 40 determines that the traveling state is stationary when the change in the position of person 100 is less than a predetermined value, and determines that the traveling state is not stationary but a moving state when the change in the position of person 100 is greater than or equal to the predetermined value. More specifically, controller 40 determines that the traveling state is stationary when the following criteria for determining the traveling state are satisfied: the change in the position of person 100 is less than 8.9 mm between the detection result in the N-th measurement and the detection result in the N+M-th measurement, when the measurement interval of detector 60c is 0.1 seconds and numerical value M=1.

In the above description, controller 40 determines the traveling state of the person on the basis of the two detection results outputted by any one of detectors 60a through 60c, but may also determine the traveling state on the basis of three or more detection results.

Next, the case is described where the detector is configured in the form of a speed sensor (speed-measuring device). FIG. 24 is a top view showing an example of the case where detector 60d according to the present embodiment is configured in the form of a speed sensor. In FIG. 24, the illustration of the elements of imaging apparatus 10 other than reflectors 22 and detector 60d is omitted.

Imaging apparatus 10 may include detector 60d instead of detector 60. As shown in FIG. 24, detector 60d is configured in the form of a speed sensor that measures the traveling speed of person 100. Detector 60d is provided, for example, on the first direction side of reflectors 22 (i.e., the first direction side of imaging space 102). Detector 60d outputs the detection results indicating the traveling speed at which person 100 is traveling in imaging space 102. Detector 60d is capable of detecting the traveling state of person 100 by means of the speed sensor detecting the traveling speed of person 100 traveling in imaging space 102.

Controller 40 determines whether the traveling state of person 100 is stationary on the basis of the traveling speed of person 100 detected by detector 60d. Controller 40 determines that the traveling state is stationary when the traveling speed of person 100 is less than a predetermined value, and determines that the traveling state is not stationary but a moving state when the traveling speed of person 100 is greater than or equal to the predetermined value. More specifically, controller 40 determines that the traveling state is stationary when the following criterion for determining the traveling state is satisfied: when the traveling speed of person 100 is less than 889 mm per second. Even when any one of detectors 60 to 60c is used, controller 40 may calculate the traveling speed of person 100 from the detection results of detectors 60 to 60c, and determine whether the traveling state of person 100 is stationary, on the basis of the calculated traveling speed of person 100.

The foregoing specific examples of the criteria for determining the traveling state are based on the detection results that are obtained when person 100 is traveling at a speed of less than 3.2 km per hour (=889 mm per second), which is the traveling speed of a typical person. Such examples of the criteria for the determination are mere examples and thus not limited to these. The traveling speed of person 100 serving as a criterion for the determination is, for example, (B×λ/2)/T mm per second, when the wavelength of a sub-terahertz wave emitted by emitter 20 is taken as A mm and the duration of the exposure period of image sensor 31 is taken as T seconds. Constant B is, for example, a numerical value between 1 and 15, inclusive, or between 7 and 15, inclusive, which is set in accordance with, for example, the specifications of emitter 20 and detection device 30.

When controller 40 determines that the traveling state is a moving state on the basis of the traveling state detected by any one of detectors 60 to 60d, controller 40 may further determine the degree of travel. For example, a predetermined threshold that is different from the criteria for determining whether person 100 is stationary is set, and controller 40 determines whether the amount of travel while person 100 is traveling is small or large, on the basis of whether a value that is based on the traveling state is smaller than or equal to the predetermined threshold. The degree of travel while person 100 is traveling is not limited to being classified into two levels, and thus may be classified into three or more levels of travel.

### [Other Elements]

With reference to FIG. 3 and FIG. 4 again, other elements included in imaging apparatus 10 are described.

Alarm 70 issues a warning to person 100. The warning is issued, for example, to inform person 100 of that the traveling speed is low or the traveling state of such person is stationary. Alarm 70 includes, for example, at least one of a light source, a speaker, or a display, and issues a warning, using at least one of light, sound, or image. Alarm 70 may issue a warning by simply emitting light or sound, or by displaying information indicating that the traveling state of person 100 is stationary or information for prompting person 100 to change the traveling state, by, for example, increasing the traveling speed. Note that imaging apparatus 10 may not include alarm 70.

Conveyer 80 is a conveyance device that moves person 100 within imaging space 102 under a predetermined condition. Conveyer 80 may be constantly in operation or may be controlled whether to operate where necessary. Phase modulator 50 may include conveyer 80 in addition to or instead of phase difference plate 51 and driver 52. Note that imaging apparatus 10 may not include conveyer 80.

Conveyer 80 moves person 100, for example, by half the wavelength or more of the sub-terahertz wave emitted by light sources 21 during the exposure period of image sensor 31, thereby changing the angular distribution of the phases of the sub-terahertz wave received by image sensor 31. The speed at which conveyer 80 moves person 100 may be, for example, (λ/2)/T mm per second or higher, when, for example, the wavelength of the sub-terahertz wave emitted by light sources 21 is taken as A mm and the exposure period of image sensor 31 is taken as T seconds, and thus may be (7×λ/2)/T mm per second or higher. For safety reasons, the speed at which conveyer 80 moves person 100 may also be (30×λ/2)/T mm per second or less.

Image processor 90, when receiving images from detection device 30, for example, outputs the received images to outside, performs image processing on the received images, and outputs the result of the image processing to outside.

The image processing performed by image processor 90 may be processing, for example, for determining whether the images outputted from detection device 30 include an object having predetermined characteristics (e.g., object with the characteristics of a blade), and outputting a predetermined detection signal, when it is determined that the images include an object with the predetermined characteristics, (e.g., a warning indicating that an image of an object having the characteristics of a blade is captured). Image processor 90 includes, for example, a processor and memory, and is implemented by means of the processor executing a program stored in the memory. Controller 40 and image processor 90 may share the processor and the memory.

Note that imaging apparatus 10 may not include image processor 90, and detection device 30 may output images to an external image processing apparatus. Also, detection device 30 may have the functions of image processor 90.

Display 95 displays images on the basis of the control performed by controller 40. For example, display 95 displays the images generated by detection device 30. This enables the user to check the images. Display 95 may also display images other than the images generated by detection device 30, such as images showing the result of the image processing performed by image processor 90. Display 95 is realized, for example, by means of a display panel, such as a liquid crystal panel or an organic EL panel.

### [Variation 1]

The following describes Variation 1 of the embodiment. The following description focuses on the differences from the embodiment, and omits or simplifies the descriptions of the common points.

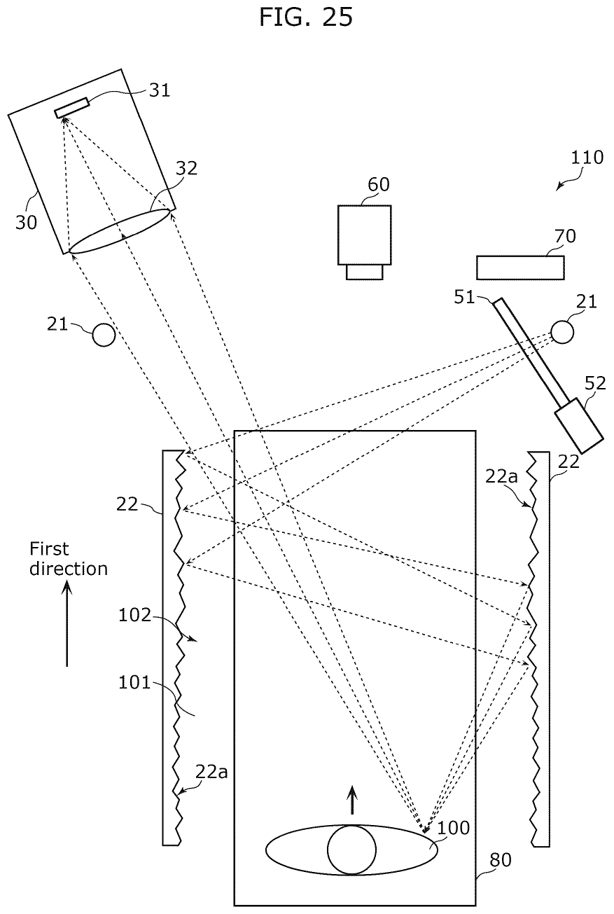

FIG. 25 is a schematic diagram showing imaging apparatus 110 according to the present variation viewed from above. As shown in FIG. 25, imaging apparatus 110 is different from imaging apparatus 10 according to the embodiment in that phase difference plate 51 is disposed between light source 21 and reflector 22 instead of being disposed on the optical path of the reflected wave that enters optical system 32. In the present variation, phase difference plate 51 transmits the sub-terahertz wave emitted from light source 21, and changes the phase of the sub-terahertz wave that transmits therethrough. Stated differently, in the present variation, phase modulator 50 changes the phase of at least some components of the sub-terahertz wave emitted to person 100, thereby changing the angular distribution of the phase of the reflected wave to be received by image sensor 31.

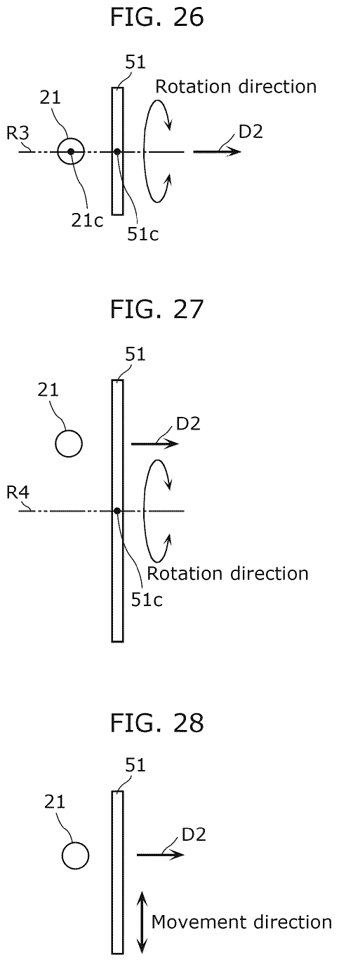

Phase difference plate 51 can have, for example, various shapes described above with reference to FIG. 9, FIG. 12, FIG. 14, etc. Here, the movement of phase difference plate 51 is described. FIG. 26 is a schematic diagram for explaining an example of the movement of one example of phase difference plate 51 according to the present variation. FIG. 27 is a schematic diagram for explaining an example of the movement of another example of phase difference plate 51 according to the present variation. FIG. 28 is a schematic diagram for explaining an example of the movement of still another example of phase difference plate 51 according to the present variation.

When the foregoing examples of phase difference plate 51 shown in FIG. 9 and FIG. 10 are used, for example, phase difference plate 51 is moved as shown in FIG. 26. More specifically, phase difference plate 51 is rotated by driver 52, for example, about rotation axis R3, which passes through light emission center 21c of light source 21 and has an inclination angle between −10° and 10°, inclusive, with respect to the direction parallel to emission direction D2 in which light source 21 emits a sub-terahertz wave. Phase difference plate 51 rotates, for example, at least once during the exposure period of image sensor 31. The rotation speed of phase difference plate 51 is not limited to a specific speed, and thus may be any speeds at which phase difference plate 51 can be rotated by driver 52. Emission direction D2 in which light source 21 emits a sub-terahertz wave is, for example, the direction of the optical axis of light source 21, i.e., the direction serving as the center of the range over which light source 21 emits a sub-terahertz wave. Rotation axis R3 is, for example, parallel to the thickness direction of phase difference plate 51 and passes through center 51c of phase difference plate 51 in a plan view. Note that rotation axis R3 may not pass through center 51c of phase difference plate 51. Also, rotation axis R3 may pass through a position other than light emission center 21c of light source 21. Also, rotation axis R3 may not be parallel to the thickness direction of phase difference plate 51, and may be inclined with respect to the thickness direction (e.g., inclined at an inclination angle between −10° and 10°, inclusive).

When the foregoing another example of phase difference plate 51 shown in FIG. 12 is used, for example, phase difference plate 51 is moved as shown in FIG. 27. More specifically, phase difference plate 51 is rotated by driver 52, for example, about rotation axis R4, which does not pass through light source 21 and has an inclination angle between −10° and 10°, inclusive, with respect to the direction parallel to emission direction D2 in which light source 21 emits a sub-terahertz wave. Phase difference plate 51 rotates, for example, at least once during the exposure period of image sensor 31. The rotation speed of phase difference plate 51 is not limited to a specific speed, and thus may be any speeds at which phase difference plate 51 can be rotated by driver 52. Rotation axis R4 is, for example, parallel to the thickness direction of phase difference plate 51 and passes through center 51c of phase difference plate 51 in a plan view. Note that rotation axis R4 may not pass through center 51c of phase difference plate 51. Also, rotation axis R4 may not be parallel to the thickness direction of phase difference plate 51, and may be inclined with respect to the thickness direction (e.g., inclined at an inclination angle between −10° and 10°, inclusive).

When the foregoing still another example of phase difference plate 51 shown in FIG. 14 is used, for example, phase difference plate 51 is moved as shown in FIG. 28. More specifically, phase difference plate 51 is moved by driver 52, for example, in the direction orthogonal to emission direction D2 in which light source 21 emits a sub-terahertz wave and the direction orthogonal to the thickness direction of phase difference plate 51. Phase difference plate 51 is moved, for example, back and forth at a predetermined frequency in the movement direction. The predetermined frequency is, for example, a frequency whose period is less than or equal to the exposure period of image sensor 31. Also, the upper limit of the predetermined frequency is not limited to a specific limit, and thus may be any frequencies at which phase difference plate 51 can be moved back and forth by driver 52.

As described above, by phase difference plate 51 being moved as shown in FIG. 26 through FIG. 28, the positions of first region 51a and second region 51b are switched at a position through which the sub-terahertz wave emitted from light source 21 passes. With this, it is possible to change the phase of the sub-terahertz wave emitted to person 100, thereby changing the angular distribution of the phase of the reflected wave to be received by image sensor 31 during the exposure period of image sensor 31.

### [Variation 2]

The following describes Variation 2 of the embodiment. The following description focuses on the differences from the embodiment, and omits or simplifies the descriptions of the common points.

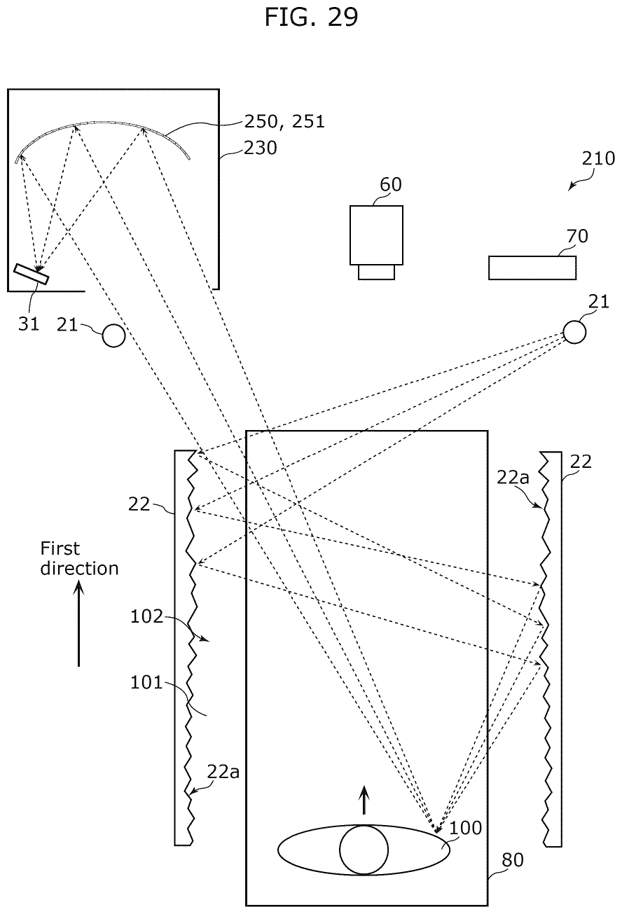

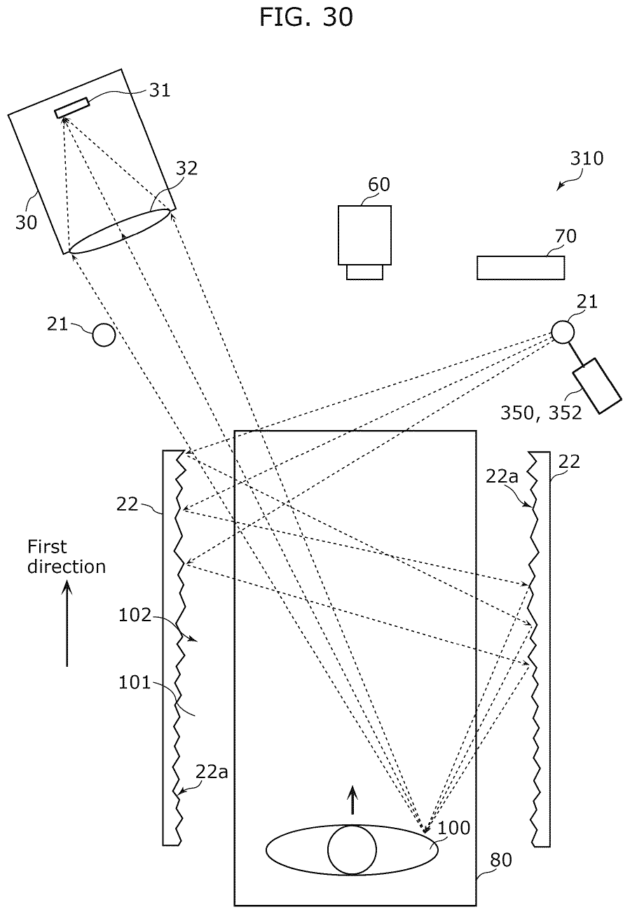

FIG. 29 is a schematic diagram showing imaging apparatus 210 according to the present variation viewed from the above. As shown in FIG. 29, imaging apparatus 210 is different from imaging apparatus 10 according to the embodiment in that detection device 230 and phase modulator 250 are provided instead of detection device 30 and phase modulator 50.

Detection device 230 is different from detection device 30 in that, instead of optical system 32, mirror system 251 included in phase modulator 250 serves as the optical system. Stated differently, phase modulator 250 forms at least part of the optical system of detection device 230, and the optical system of detection device 230 includes mirror system 251 as phase modulator 250.

In the present variation, phase modulator 250 changes the phase of some components of the reflected wave, which is the sub-terahertz wave emitted from emitter 20 and reflected by person 100, thereby changing the angular distribution of the phases of the reflected wave to be received by image sensor 31.

Mirror system 251 images the reflected wave, which is the sub-terahertz wave emitted from emitter 20 and reflected by person 100, onto image sensor 31. Mirror system 251 includes, for example, a plurality of mirrors disposed to form a curved surface. The plurality of mirrors in mirror system 251 change the phases of the reflected wave from person 100 that enters the plurality of mirrors during the exposure period of image sensor 31, when such reflected wave is reflected. For example, in mirror system 251, the phase change characteristics of each of the plurality of mirrors change when the mirror reflects the reflected wave during the exposure period of image sensor 31. In mirror system 251, the amount of phase change to the reflected wave from person 100 can vary on a mirror-by-mirror basis. For example, at a certain point in time, some of the plurality of mirrors in mirror system 251 reflect the reflected wave from person 100 without changing the phase of such reflected wave, and other mirrors reflect the reflected wave from person 100 after changing the phase of such reflected wave. The characteristics of these mirrors change with time. The use of such mirror system 251 makes it possible to change the angular distribution of the phases of the reflected wave to be received by image sensor 31. The mirrors that change the phase reflect the reflected wave, for example, after changing the phase by 180°. Mirror system 251 includes, for example, of reflective spatial light phase modulation elements including, for example, a circuit that controls the phase change.

As described above, by detection device 30 and phase modulator 250 being provided in an integrated form, it is possible to simplify the structure of imaging apparatus 210.

### [Variation 3]

The following describes Variation 3 of the embodiment. The following description focuses on the differences from the embodiment, and omits or simplifies the descriptions of the common points.

FIG. 30 is a schematic diagram showing imaging apparatus 310 according to the present variation viewed from above. As shown in FIG. 30, imaging apparatus 310 is different from imaging apparatus 10 according to the embodiment in that phase modulator 350 is provided instead of phase modulator 50.

Phase modulator 350 changes the phase of the sub-terahertz wave emitted to person 100, thereby changing the angular distribution of the phases of the reflected wave to be received by image sensor 31.

Phase modulator 350 includes driver 352. Driver 352 is an example of the light source driver. Driver 352 is a driving device that moves light source 21 under a predetermined condition, thereby changing the angular distribution of the phases of the reflected wave to be received by image sensor 31. For this reason, light source 21 is movably disposed in imaging apparatus 310, without being fixed.

For example, driver 352 moves light source 21 such that the phase of the sub-terahertz wave emitted to person 100 changes during the exposure period of image sensor 31, thereby changing the angular distribution of the phases of the reflected wave from person 100 that is received by image sensor 31. More specifically, when light source 21 is moved, the optical path length through which the sub-terahertz wave emitted from light source 21 travels to enter person 100 changes. This results in a change in the phase of the sub-terahertz wave at each position on person 100 from which the sub-terahertz wave enters person 100. As a result, the angular distribution of the phases of the reflected wave from person 100 that is received by image sensor 31 changes.

Driver 352 includes, for example, a driving machine such as a motor and an actuator, and a power transmission member such as a belt, a gear, a pulley, and a connecting shaft for transmitting power to light source 21.

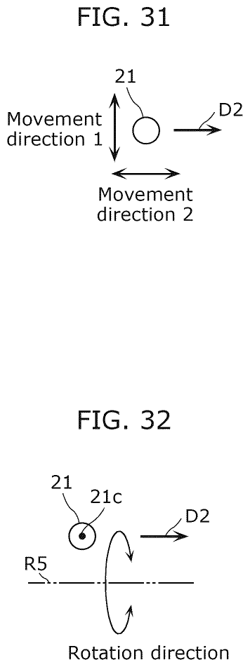

Here, the movement of light source 21 in the present variation is described. FIG. 31 is a schematic diagram for explaining an example of the movement of light source 21 according to the present variation. FIG. 32 is a schematic diagram for explaining another example of the movement of light source 21 according to the present variation.

As shown in FIG. 31, light source 21 is moved, for example, back and forth by driver 352 at a predetermined frequency in movement direction 1 that is vertical to emission direction D2 in which light source 21 emits a sub-terahertz wave or in movement direction 2 that is parallel to emission direction D2. The predetermined frequency is, for example, a frequency whose period is less than or equal to the exposure period of image sensor 31. Also, the upper limit of the predetermined frequency is not limited to a specific limit, and thus may be any frequencies at which light source 21 can be moved back and forth by driver 352. The range of oscillation in this case is, for example, greater than or equal to the wavelength of the sub-terahertz wave emitted by light source 21. As such, light source 21 is moved such that the range of movement is greater than or equal to the wavelength of the sub-terahertz wave emitted by light source 21 during the exposure period of image sensor 31. As a result, the optical path length through which the sub-terahertz wave emitted from light source 21 travels to enter person 100 changes by the wavelength of the sub-terahertz wave or more. This effectively changes the angular distribution of the phases of the reflected wave from person 100 that is received by image sensor 31. The range of oscillation in this case is set, for example, in a range in which reflectors 22 are irradiated with the sub-terahertz wave emitted by light source 21 at any positions of the back-and-forth movement. Note that light source 21 may be moved back and forth in the direction between movement direction 1 and movement direction 2 (i.e., in the direction of the combined vector).

Also, as shown in FIG. 32, light source 21 is rotated by driver 352, for example, about rotation axis R5, which does not pass through light emission center 21c of light source 21 and is in the direction parallel to emission direction D2 in which light source 21 emits the sub-terahertz wave. Stated differently, light source 21 is moved such that light emission center 21c draws a circular trajectory. In an example shown in FIG. 32, rotation axis R5 does not pass through any positions in light source 21. As described above, by light source 21 being moved to draw a circular trajectory, it is possible for light source 21 to keep moving without stopping. This effectively changes the optical path length through which the sub-terahertz wave emitted by light source 21 travels to enter image sensor 31. The length of the trajectory at this time is, for example, greater than or equal to the wavelength of the sub-terahertz wave emitted by light source 21. The length of the trajectory at this time is, for example, greater than or equal to the wavelength of the sub-terahertz wave emitted by light source 21. Also, the diameter of the trajectory at this time may be greater than or equal to the wavelength of the sub-terahertz wave emitted by light source 21. Also, the length of the trajectory at this time may be set, for example, in the range in which reflector 22 is irradiated with the sub-terahertz wave emitted by light source 21 at any positions on the trajectory. Note that rotation axis R5 may intersect with emission direction D2 or may be orthogonal to emission direction D2, as long as rotation axis R5 does not pass through light emission center 21c.

### [Variation 4]

The following describes Variation 4 of the embodiment. The following description focuses on the differences from the embodiment, and omits or simplifies the descriptions of the common points.

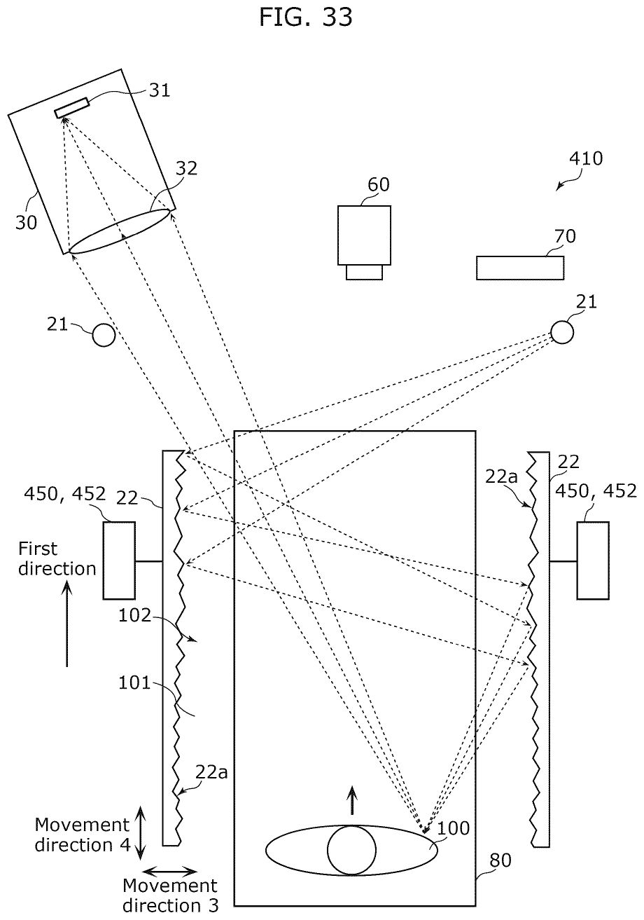

FIG. 33 is a schematic diagram showing imaging apparatus 410 according to the present variation viewed from above. As shown in FIG. 33, imaging apparatus 410 is different from imaging apparatus 10 according to the embodiment in that phase modulators 450 are provided instead of phase modulator 50.

Each of phase modulators 450 changes the phase of the sub-terahertz wave emitted to person 100, thereby changing the angular distribution of the phases of the reflected wave to be received by image sensor 31.

Each modulator 450 includes driver 452. Driver 452 is an example of the reflector driver. Driver 452 is a driving device that moves reflector 22 under a predetermined condition, thereby changing the angular distribution of the phases of the reflected wave to be received by image sensor 31. For this reason, reflector 22 is movably disposed in imaging apparatus 410, without being fixed.

For example, driver 452 moves reflector 22 such that the phase of the sub-terahertz wave emitted to person 100 changes during the exposure period of image sensor 31, thereby changing the angular distribution of the phases of the reflected wave from person 100 that is received by image sensor 31. More specifically, when reflector 22 is moved, the optical path length through which the sub-terahertz wave emitted from light source 21 travels to enter person 100 changes. This results in a change in the phase of the sub-terahertz wave at each position on person 100 from which the sub-terahertz wave enters person 100. As a result, the angular distribution of the phases of the reflected wave from person 100 that is received by image sensor 31 changes.

Driver 452 includes, for example, a driving machine such as a motor and an actuator, and a power transmission member such as a belt, a gear, a pulley, and a connecting shaft for transmitting power to reflector 22.

Here, the movement of reflector 22 according to the present variation is described. As shown in FIG. 33, reflector 22 is moved, for example, back and forth by driver 452 at a predetermined frequency in movement direction 3 that is parallel to the thickness direction of reflector 22. The predetermined frequency is, for example, a frequency whose period is less than or equal to the exposure period of image sensor 31. Also, the upper limit of the predetermined frequency is not limited to a specific limit, and thus may be any frequencies at which reflector 22 can be moved back and forth by driver 452. The range of oscillation at this time is, for example, greater than or equal to half the wavelength of the sub-terahertz wave emitted by light source 21. As such, reflector 22 is moved, for example, such that the range of movement in the thickness direction of reflector 22 is greater than or equal to half the wavelength of the sub-terahertz wave emitted by light source 21 during the exposure period of image sensor 31. When the position of reflector 22 is moved in the thickness direction of reflector 22 by half the wavelength of the sub-terahertz wave or more, the optical path length through which the sub-terahertz wave emitted from light source 21 is reflected by reflector 22 and enters person 100 changes by the wavelength of the sub-terahertz wave or more. This effectively changes the angular distribution of the phases of the reflected wave from person 100 that is received by image sensor 31. The range of oscillation at this time is set to a range in which imaging space 102 that person 100 passes through can be secured and person 100 passing through imaging space 102 is irradiated with the sub-terahertz wave emitted from surface 22a.

Reflector 22 may also be moved, for example, back and forth by driver 452 at a predetermined frequency in movement direction 4 that is vertical to the thickness direction of reflector 22. The predetermined frequency is, for example, a frequency whose period is less than or equal to the exposure period of image sensor 31. Also, the upper limit of the predetermined frequency is not limited to a specific limit, and thus may be any frequencies at which reflector 22 can be moved back and forth by driver 452. The range of oscillation at this time is, for example, greater than or equal to the wavelength of the sub-terahertz wave emitted by light source 21. As such, reflector 22 is moved, for example, such that the range of movement in the direction vertical to the thickness direction of reflector 22 is greater than or equal to the wavelength of the sub-terahertz wave emitted by light source 21 during the exposure period of image sensor 31. When the position of reflector 22 is moved in the direction vertical to the thickness direction of reflector 22 by the wavelength of the sub-terahertz wave or more, the positions of the asperities on surface 22a are shifted, which are set in accordance with the wavelength of the sub-terahertz wave for diffusely reflecting the sub-terahertz wave. This effectively changes the direction in which the sub-terahertz wave is diffusely reflected by reflector 22. As a result, it is possible to effectively change the angular distribution of the phases of the reflected wave from person 100 that is received by image sensor 31.

Note that reflector 22 may be moved back and forth in the direction between movement direction 3 and movement direction 4 (i.e., in the direction of the combined vector) such that the range of movement falls within the foregoing range of movement of reflector 22.

### [Effects of Change in Optical Path Length of Sub-Terahertz Wave]

The following describes the effects achieved by changing the optical path length through which a sub-terahertz wave emitted from light source 21 enters image sensor 31 after being reflected by person 100, when images are captured using the imaging apparatuses according to the embodiment and variations.

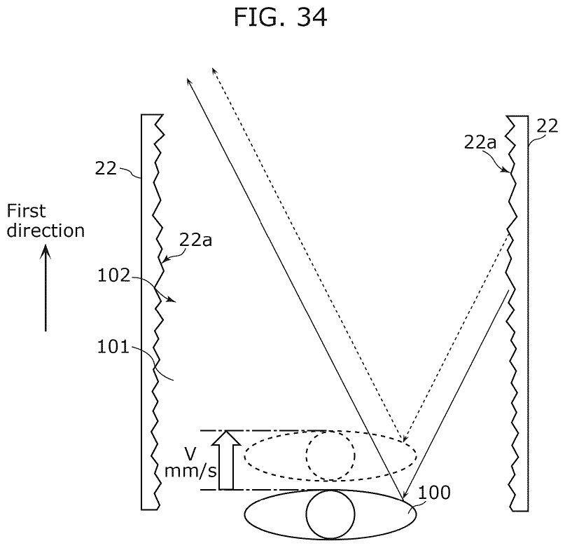

FIG. 34 is a diagram for explaining a change in the optical path length of a sub-terahertz wave caused by the travel of person 100. FIG. 34 shows person 100 traveling at speed v in the first direction in imaging space 102. FIG. 34 shows, by sloid lines, (i) person 100, (ii) an example of the sub-terahertz wave incident on person 100, and (iii) an example of the reflected wave from person 100, before person 100 travels. FIG. 34 also shows, by broken lines, (i) person 100, (ii) an example of the sub-terahertz wave incident on person 100, and (iii) an example of the reflected wave from person 100, after the elapse of the exposure period of one frame of image sensor 31 from the state before person 100 travels. For ease of viewing, FIG. 34 shows the amount of travel of person 100 in an exaggerated manner.

As shown in FIG. 34, the sub-terahertz wave emitted to person 100 is reflected by person 100 to travel toward image sensor 31. For this reason, when person 100 travels in the first direction, the optical path length through which the sub-terahertz wave emitted from light source 21 travels to enter image sensor 31 after being reflected by person 100 changes by approximately twice the length of the travel of person 100.

To effectively change the pattern of the angular distribution of the phases of the reflected wave on image sensor 31 for the control of uneven brightness in an image, for example, the foregoing optical path length is changed by the wavelength of the sub-terahertz wave or more. As a result, the pattern of the angular distribution of the phases of the reflected wave to be received by image sensor 31 is shifted by the wavelength of the sub-terahertz wave. The amount of travel of person 100 required to change the foregoing optical path length by the amount of the wavelength of the sub-terahertz wave or more is half the wavelength of the sub-terahertz wave. For this reason, by setting the exposure period of image sensor 31 to be a duration required by person 100 to travel by half the wavelength of the sub-terahertz wave, it is possible for image sensor 31 to accumulate the intensity between two patterns of the angular distribution of the phases that are shifted by the wavelength of the sub-terahertz wave during the exposure period. As a result, the intensity of the reflected wave with different angular distributions of the phases is accumulated, thereby leveling out brightness and darkness caused by interference. For example, as described with reference to FIG. 1, when the angular distribution of the phases of the reflected wave at position P1 shown in (a) in FIG. 1 and the angular distribution of the phases of the reflected wave at position P2 shown in (b) FIG. 1 occur during the exposure period regarding the reflected wave that is reflected not at different reflection positions but at the same reflection position on person 100, brightness and darkness caused by signals corresponding to the intensity of the reflected wave accumulated during the exposure period is leveled out.

More specifically, when the traveling speed of person 100 is taken as v mm per second and the wavelength of the sub-terahertz wave emitted by emitter 20 is taken as A mm, person 100 travels by half the wavelength of the sub-terahertz wave or more during the exposure period, when the duration of the exposure period is (λ/2)/v seconds or longer. For this reason, when the traveling speed of person 100 is taken as 3.2 km per hour (=889 mm per second), which is the traveling speed of a typical person, and the duration of the exposure period is set to λ/1778 seconds or longer, it is possible to effectively control uneven brightness that occurs in an image regardless of the property of person 100 of reflecting a sub-terahertz wave. When the duration of the exposure period of image sensor 31 is the foregoing duration, for example, it is possible for imaging apparatus 10 to control uneven brightness in the image even without including phase modulator 50.

The effects of leveling out brightness and darkens is enhanced as the amount of travel of person 100 during the exposure period of image sensor 31 increases. The inventors have simulated and studied the case where an imaging target with uniform reflectivity as shown and described in FIG. 1 is irradiated with sub-terahertz wave, and reached the result that the ratio of pixel values in the darkest portion to the brightest portion is 0.25 or lower by adding up the intensities of the patterns of the angular distribution of eight phases that are shifted by the wavelength of the sub-terahertz wave. For this reason, to cause the foregoing optical path length to change by seven wavelengths of the sub-terahertz wave or more during the exposure period, i.e., by setting the duration of the exposure period to be (7×λ/2)/v seconds or longer, it is possible to more effectively control uneven brightness. For example, as with the foregoing description, when the traveling speed of person 100 is taken as 889 mm per second, it is possible to more effectively control uneven brightness by setting the duration of the exposure period to λ/254 seconds or longer.

In the same principle, also for the case where phase modulator 350 or phase modulator 450 changes the optical path length through which the sub-terahertz wave emitted from light source 21 travels to reach person 100, as in Variation 3 and Variation 4 described above, it is possible to effectively control uneven brightness that occurs in an image regardless of the property of person 100 of reflecting a sub-terahertz wave, by changing the optical path length by the wavelength of the sub-terahertz wave or more during the exposure period.

The above description provides an example of accumulating the intensity of the reflected wave during the exposure period of one frame of image sensor 31, but the same effects can be achieved when the intensity of the reflected wave is accumulated during the exposure periods of a plurality of frames.

Even when the duration of the exposure period is less than λ/1778 seconds, it is possible for image sensor 31 to accumulate the intensity of the reflected wave with different angular distributions of the phase and level out brightness and darkness caused by interference also by means of phase modulators 50, 250, 350, and 450 changing the angular distribution of the phases of the reflected wave to be received by image sensor 31 during the exposure period of image sensor 31. It is thus possible to effectively control uneven brightness that occurs in an image regardless of the property of person 100 of reflecting a sub-terahertz wave. For example, when phase modulators 50, 250, 350, and 450 change the angular distribution of the phases of the reflected wave to be received by image sensor 31 during the exposure period of image sensor 31, the duration of the exposure period may be λ/2000 seconds or less.

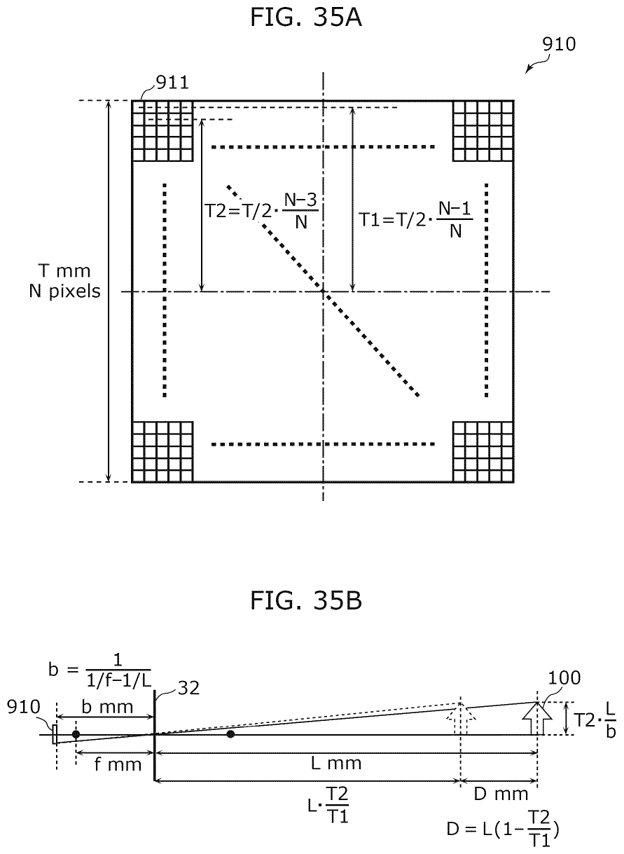

From the viewpoint of controlling blurring by receiving the reflected wave from the same point on person 100 mainly by the same pixel 911 during the exposure period, the duration of the exposure period may be set to a predetermined duration or less, on the basis of the imaging distance of detection device 30 and the arrangement of pixels 911 in pixel array 910 of image sensor 31. Here, with reference to FIG. 35A and FIG. 35B, the exposure period for controlling blurring is described.

FIG. 35A is a schematic diagram showing an example of the arrangement of pixels 911 in pixel array 910 in image sensor 31. FIG. 35B is a schematic diagram showing an example of imaging distance L of detection device 30. FIG. 35B schematically shows only pixel array 910 and optical system 32 among the elements of detection device 30. Also, FIG. 35B indicates, by the solid line arrow, person 100 to be imaged, and indicates, by the broken line arrow, person 100 to be imaged with a shift of one pixel with respect to person 100 indicated by the solid line arrow.

As shown in FIG. 35A, the length of one side of pixel array 910 is taken as T mm and the number of pixels 911 on such side is taken as N pixels. Also, the distance from the center of pixel array 910 to pixels 911 in the edge rows of pixel array 910 is taken as T1, and the distance from the center of pixel array 910 to pixels 911 in the second rows from the edges of pixel array 910 is taken as T2. In this case, distances T1 and T2 are as shown in FIG. 35A.

As shown in FIG. 35B, the imaging distance from optical system 32 of detection device 30 to person 100, which is the imaging target, is taken as L mm, the distance between pixel array 910 and optical system 32 is taken as b mm, the focal distance of optical system 32 is taken as f mm, and the travel distance of person 100 when such person 100 is imaged with a shift of one pixel is taken as D mm. Also assume that, when person 100 is imaged with a shift of one pixel, the reflected light from person 100 also enters pixels 911 in the edge rows of pixel array 910. In this case, D=L(1−T2/T1) is satisfied as shown in FIG. 35B. For this reason, when person 100 travels at a speed of 889 mm per second and the duration of the exposure period is L(1−T2/T1)/889 seconds, the reflected light from person 100 enters pixel array 910 with a shift of one pixel. From the viewpoint of controlling blurring, the duration of the exposure period is, for example, L(1−T2/T1)/1778 seconds or less, with which the shift of the reflected light from person 100 entering pixel array 910 is reduced to be half a pixel or less. Also, when number N of pixels 911 on one side of pixel array 910 is taken as 32 and length T of one side of pixel array 910 is taken as 100, distances T1 and T2 are calculated from the conditions shown in FIG. 35A to be L(1−T2/T1)/1778=L/27800. Stated differently, the duration of the exposure period may be L/27800 or less. Imaging distance L in this case is, for example, the shortest imaging distance in detection device 30 when an image of person 100 is captured. More specifically, the shortest imaging distance L in detection device 30 is, for example, the shortest distance between imaging space 102 and optical system 32.

### [Example Operations]

The following describes example operations performed by the imaging apparatuses according to the embodiment and variations. The following description focuses mainly on the operation performed by imaging apparatus 10 according to the embodiment, but the imaging apparatuses according to each of the variations are also capable of performing the same operation. The example operations described below are examples for the case where controller 40 controls the operation performed in imaging apparatus 10, on the basis of the traveling state of person 100 who passes through imaging space 102.

The imaging apparatuses according to the embodiment and variations may perform one of or a combination of two or more of the example operations described below. The imaging apparatuses according to the embodiment and variations may be imaging apparatuses that do not perform the operations described below. In the example operations described below, the case is described where detector 60 detects the traveling state of person 100, but any one of detectors 60a to 60d may detect the traveling state of person 100 instead of detector 60.

### (1) Example Operation 1

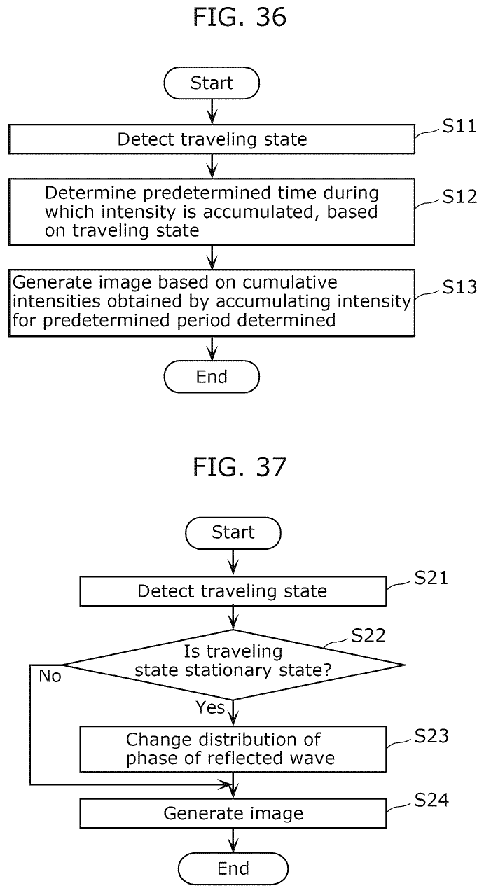

First, Example Operation 1 performed by the imaging apparatuses according to the embodiment and variations is described. FIG. 36 is a flowchart of Example Operation 1 performed by the imaging apparatuses according to the embodiment and variations.

In Example Operation 1, as shown in FIG. 36, when person 100 enters imaging space 102, detector 60 in imaging apparatus 10 detects the traveling state of person 100 (step S11). Detector 60 detects the traveling state of person 100 by, for example, obtaining a moving image of person 100 who is traveling.

Next, controller 40 determines a predetermined time during which the intensity of the reflected wave received by image sensor 31 is accumulated, on the basis of the traveling state of person 100 detected by detector 60 in step S11 (step S12). For example, controller 40 determines whether the traveling state of person 100 is stationary, using the method described in [Detector] above. When the traveling state of person 100 is stationary, controller 30 determines, as the predetermined time, time that is longer than the time for the case where the traveling state of person 100 is not stationary. When the traveling state of person 100 is not stationary, controller 40 may further determine the degree of travel of person 100 and determine the predetermined time on the basis of such degree of travel. Also, for example, controller 40 calculates the traveling speed of person 100 from the detection results of detector 60, and when the traveling speed of person 100 is taken as v mm per second and the wavelength of the sub-terahertz wave emitted by emitter 20 is taken as A mm, controller 40 determines the predetermined time to be (A×λ/2)/v seconds. Constant A is, for example, a numerical value between 1 and 15, inclusive, or between 7 and 15, inclusive, which is set in accordance with, for example, the specifications of emitter 20 and detection device 30.

Next, controller 40 causes image sensor 31 to generate an image on the basis of the signals corresponding to the cumulative intensities accumulated for the predetermined time determined in step S12 (step S13). As a result, an image showing person 100 is captured.

As described above, the optical path length through which the sub-terahertz wave emitted from light source 21 travels to enter image sensor 31 changes in response to the travel of person 100. Also, the amount of change in the above optical path length within the predetermined time during which the intensity of the reflected wave received by image sensor 31 is accumulated is determined by the traveling state of person 100 (e.g., traveling speed of person 100). Further, the distribution of the phases with respect to the reflection angles of the reflected wave received by image sensor 31 also changes in response to the change in the above optical path length. As such, the traveling state of person 100 affects the distribution of the phases with respect to the reflection angles of the reflected wave received by image sensor 31 during the predetermined time. The more likely the angular distribution of the phases of the reflected wave to be received by image sensor 31 changes during the predetermined time, the more reliably image sensor 31 accumulates the intensity of the reflected wave with different angular distributions of the phases and control uneven brightness in the image. Thus, whether uneven brightness is likely to occur in an image generated by image sensor 31 depends on the traveling state of person 100. In the present example operation, controller 40 determines the predetermined time in step S12 on the basis of the traveling state of person 100, thereby appropriately controlling the amount of change in the above optical path length during the predetermined time. For example, controller 40 is capable of determining the predetermined time to enable the above optical path length to be changed by the wavelength of the sub-terahertz wave or more as described above. It is thus possible for image sensor 31 to accumulate the intensity of reflected wave with different angular distributions of the phases in an appropriate predetermined time, and generate an image in which uneven brightness is controlled.

### (2) Example Operation 2

Next, Example Operation 2 performed by the imaging apparatuses according to the embodiment and variations is described. FIG. 37 is a flowchart of Example Operation 2 performed by the imaging apparatuses according to the embodiment and variations.

First, in Example Operation 2, as shown in FIG. 37, when person 100 enters imaging space 102, detector 60 in imaging apparatus 10 detects the traveling state of person 100 (step S21). Step S21 is the same as step S11 described above.

Next, controller 40 determines whether the traveling state of person 100 detected by detector 60 in step S21 is stationary (step S22). For example, controller 40 determines whether the traveling state of person 100 is stationary, on the basis of the detection results outputted from detector 60, using the method described in [Detector] above.

Next, when determining that the traveling state of person 100 is stationary (Yes in step S22), controller 40 causes phase modulator 50 to change the angular distribution of the phases of the reflected wave to be received by image sensor 31 (step S23). In step S23, controller 40 may determine the conditions for changing the angular distribution of the phases of the reflected wave, such as the speed of driving performed by driver 52, on the basis of the traveling state, such as the traveling speed of person 100, and cause phase modulator 50 to change the angular distribution of the phases of the reflected wave to be received by image sensor 31, on the basis of the determined conditions. In the operation performed by the imaging apparatus according to each of the variations, controller 40 causes the phase modulator included in the imaging apparatus according to each of the variations to change the angular distribution of the phases of the reflected wave to be received by image sensor 31, instead of phase modulator 50.

Next, controller 40 causes image sensor 31 to generate an image that is based on the received reflected wave, while causing phase modulator 50 to operate (step S24). At this time, image sensor 31 may generate an image on the basis of the signals corresponding to the cumulative intensities accumulated for a time period of λ/1778 seconds or longer.

Meanwhile, when determining that the traveling state of person 100 is not stationary (No in step S22), controller 40 causes image sensor 31 to generate an image that is based on the received reflected wave, without causing phase modulator 50 to operate (step S24).

In Example Operation 2, controller 40 causes phase modulator 50 to change the angular distribution of the phases of the sub-terahertz wave received by image sensor 31, when the traveling state of person 100 is stationary. For this reason, even when the change in the angular distribution of the phases of the reflected wave to be received by image sensor 31 is small due to that the traveling state of person 100 is stationary, such as in the case where the traveling speed of person 100 is low or person 100 is standing still, phase modulator 50 changes the angular distribution of the phases of the reflected wave to be received by image sensor 31. It is thus possible to control uneven brightness in the resulting image.

In Example Operation 2, instead of determining whether the traveling state of person 100 is stationary, controller 40 may determine whether person 100 is present in a predetermined space, on the basis of the detection results of detector 60. For example, when determining that person 100 is present in the predetermined space, controller 40 causes phase modulator 50 to change the angular distribution of the phases of the reflected wave to be received by image sensor 31 and causes image sensor 31 to generate an image that is based on the received reflected wave, regardless of the traveling state of person 100. With this, it is possible to control uneven brightness in the resulting image in a more reliable manner.

### (3) Example Operation 3

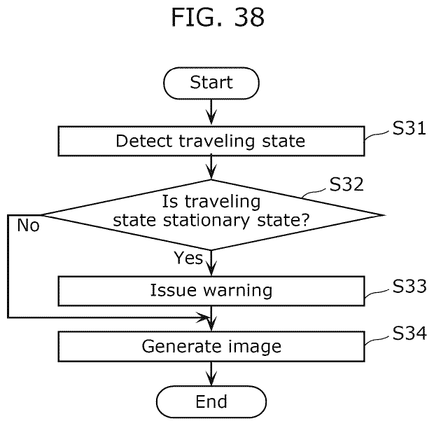

Next, Example Operation 3 performed by the imaging apparatuses according to the embodiment and variations is described. FIG. 38 is a flowchart of Example Operation 3 performed by the imaging apparatuses according to the embodiment and variations.

First, in Example Operation 3, as shown in FIG. 38, when person 100 enters imaging space 102, detector 60 in imaging apparatus 10 detects the traveling state of person 100 (step S31). Step S31 is the same as step S11 described above.

Next, controller 40 determines whether the traveling state of person 100 detected by detector 60 in step S31 is stationary (step S32). Step S32 is the same as step S22 described above.

Next, when determining that the traveling state of person 100 is stationary (Yes in step S32), controller 40 causes alarm 70 to issue a warning (step S33). Controller 40 then causes image sensor 31 to generate an image that is based on the received reflected wave (step S34). For example, controller 40 causes image sensor 31 to generate an image that is based on the received reflected wave when a certain duration of time elapses after causing alarm 70 to issue the warning in step S33. The certain duration of time is, for example, from 0.5 seconds to 5.0 seconds or less.

Meanwhile, when determining that the traveling state of person 100 is not stationary (No in step S32), controller 40 causes image sensor 31 to generate an image that is based on the received reflected wave, without causing alarm 70 to operate (step S34).

In Example Operation 3, controller 40 causes alarm 70 to issue a warning when the traveling state of person 100 is stationary. For this reason, it is possible to prompt person 100 to change the traveling state, by, for example, increasing the traveling speed, etc. As a result, person 100 increases the traveling speed, thereby increasing a change in the angular distribution of the phases of the reflected wave to be received by image sensor 31. With this, it possible to control uneven brightness in the resulting image.

### (4) Example Operation 4

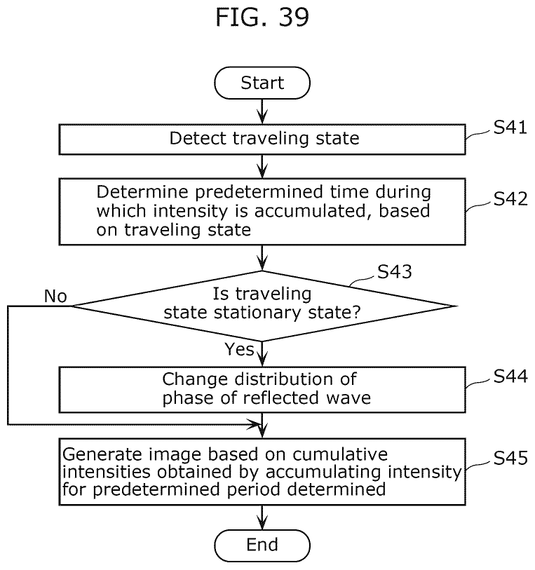

Next, Example Operation 4 performed by the imaging apparatuses according to the embodiment and variations is described. FIG. 39 is a flowchart of Example Operation 4 performed by the imaging apparatuses according to the embodiment and variations.

First, in Example Operation 4, as shown in FIG. 39, when person 100 enters imaging space 102, detector 60 in imaging apparatus 10 detects the traveling state of person 100 (step S41). Step S41 is the same as step S11 described above.

Next, controller 40 determines a predetermined time during which the intensity of the reflected wave received by image sensor 31 is accumulated, on the basis of the traveling state of person 100 detected by detector 60 in step S41 (step S42). Step S42 is the same as step S12 described above.

Next, controller 40 determines whether the traveling state of person 100 detected by detector 60 in step S41 is stationary (step S43). Step S43 is the same as step S22 described above.

Next, when determining that the traveling state of person 100 is stationary (Yes in step S43), controller 40 causes phase modulator 50 to change the angular distribution of the phases of the reflected wave to be received by image sensor 31 (step S44). Step S44 is the same as step S23 described above.

Subsequently, controller 40 causes image sensor 31 to generate an image that is based on the signals corresponding to the cumulative intensities accumulated for the predetermined time determined in step S42 (step S45). As a result, an image showing person 100 is captured.

Meanwhile, when determining that the traveling state of person 100 is not stationary (No in step S43), controller 40 causes image sensor 31 to generate an image that is based on the received reflected wave, without causing phase modulator 50 to operate (step S45).

In Example Operation 4, controller 40 causes phase modulator 50 to change the angular distribution of the phases of the reflected wave to be received by image sensor 31, when the traveling state of person 100 is stationary. Further, in step S42, controller 40 determines the predetermined time on the basis of the traveling state of person 100. This achieves both of the effects described in Example Operation 1 and Example Operation 2 of controlling uneven brightness in the resulting image, even when the traveling state of person 100 is stationary.

As described above, in Example Operations 1 to 4, controller 40 controls the operation performed by imaging apparatus 10, on the basis of the traveling state of person 100, which affects unevenness in brightness of an image. This enables the imaging conditions to be appropriately changed. For example, in Example Operations 2 to 4, controller 40 controls the operation of imaging apparatus 10 to cause it to operate differently from normal operation, when the traveling state of person 100 detected by detector 60 is stationary. With this, it is possible to control uneven brightness that occurs in an image regardless of the property of person 100 of reflecting a sub-terahertz wave.

### (5) Example Operation 5

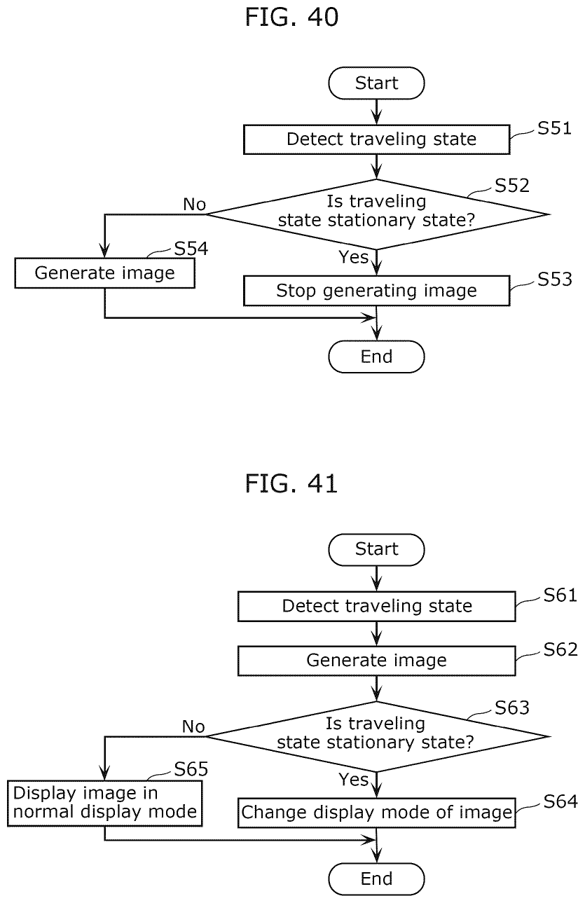

Next, Example Operation 5 performed by the imaging apparatuses according to the embodiment and variations is described. FIG. 40 is a flowchart of Example Operation 5 performed by the imaging apparatuses according to the embodiment and variations.

First, in Example Operation 5, as shown in FIG. 40, when person 100 enters imaging space 102, detector 60 in imaging apparatus 10 detects the traveling state of person 100 (step S51). Step S51 is the same as step S11 described above.

Next, controller 40 determines whether the traveling state of person 100 detected by detector 60 in step S51 is stationary (step S52). Step S52 is the same as step S22 described above.

Next, when determining that the traveling state of person 100 is stationary (Yes in step S52), controller 40 causes detection device 30 to stop image generation (step S53). As a result, imaging apparatus 10 will output no image of person 100 captured.

Meanwhile, when determining that the traveling state of person 100 is not stationary (No in step S52), controller 40 causes image sensor 31 to generate an image that is based on the received reflected wave (step S54). Image sensor 31 generates an image, for example, on the basis of the signals corresponding to the cumulative intensities accumulated for a time period of λ/1778 seconds or longer. Image sensor 31 may also generate an image, on the basis of the signals corresponding to the cumulative intensities accumulated for the predetermined time that is determined on the basis of the traveling state of person 100.

In Example Operation 5, controller 40 does not cause detection device 30 to generate an image when the traveling state of person 100 is stationary. For this reason, imaging apparatus 10 does not output an image when unevenness in brightness in the resulting image is large due to that the traveling state of person 100 is stationary. With this, since no image is outputted that leads to a decrease in the accuracy of dangerous object detection, when, for example, images are used for dangerous object detection. This prevents false detection.

### (6) Example Operation 6

Next, Example Operation 6 performed by the imaging apparatuses according to the embodiment and variations is described. FIG. 41 is a flowchart of Example Operation 6 performed by the imaging apparatuses according to the embodiment and variations.

First, in Example Operation 6, as shown in FIG. 41, when person 100 enters imaging space 102, detector 60 in imaging apparatus 10 detects the traveling state of person 100 (step S61). Step 61 is the same as step S11 described above.

Next, controller 40 causes image sensor 31 to generate an image that is based on the received reflected wave (step S62). Image sensor 31 generates an image, for example, on the basis of the signals corresponding to the cumulative intensities accumulated for a time period of λ/1778 seconds or longer. Image sensor 31 may also generate an image, on the basis of the signals corresponding to the cumulative intensities accumulated for the predetermined time that is determined on the basis of the traveling state of person 100.

Next, controller 40 determines whether the traveling state of person 100 detected by detector 60 in step S61 is stationary (step S63). Step S63 is the same as step S22 described above.

Next, when determining that the traveling state of person 100 is stationary (Yes in step S63), controller 40 causes display 95 to change the display mode of the image to be displayed (step S64). For example, controller 40 causes display 95 to stop displaying the image generated in step S62 or to overlay another image on the image generated in step S62. The other image is, for example, an image indicating that the image generated in step S62 includes large unevenness in brightness.

Meanwhile, when determining that the traveling state of person 100 is not stationary (No in step S63), controller 40 causes display 95 to display the image generated in step S62 in normal display mode (step S65).

In Example Operation 6, controller 40 causes display 95 to change the display mode of the image to be displayed, when the traveling state of person 100 is stationary. For this reason, the image generated by detection device 30 will not be displayed as it is, when unevenness in brightness in the resulting image is large due to that the traveling state of person 100 is stationary. This prevents the user, for example, from mistakenly recognizing the image generated by detection device 30, when such user is checking the image.

### OTHER EMBODIMENTS

Although the imaging apparatus according to the present disclosure has been described above on the basis of the embodiment and variations, the present disclosure is not limited to these embodiment and variations. Various modifications to the embodiment which may be conceived by those skilled in the art, as well as embodiments resulting from optional combinations of elements from different embodiments may be included within the scope of one or more aspects of the present disclosure as long as they do not depart from the scope of the present disclosure.

In the foregoing embodiment and variations, light source 21 and detection device 30 are disposed only on the first direction side of reflector 22, but the present disclosure is not limited this. Light source 21 and detection device 30 may be disposed on the side of reflector 22 opposite to the first direction side. This allows both the front side and the rear side of person 100 to be imaged.

In the foregoing embodiment and variations, the imaging target is person 100, but the present disclosure is not limited to this. The imaging target may be, for example, baggage. Imaging apparatus 10 may capture, for example, an image of baggage such as a suitcase, or a foreign object included in a product.

In the foregoing embodiment and variations, phase difference plate 51 includes both first region 51a and second region 51b, but the present disclosure is not limited to this. For example, phase difference plate 51 may include only first region 51a or second region 51b. In this case, phase difference plate 51 is moved by drive 52, for example, in a manner that phase difference plate 51 moves alternately between the positions through which at least part of the sub-terahertz wave emitted from light source 21 or at least part of the reflected wave entering optical system 32 pass and do not pass.

In the foregoing embodiment and variations, emitter 20 includes light source 21 and reflector 22, but the present disclosure is not limited to this. Emitter 20 may include, for example, a plurality of light sources that are disposed to be able to emit sub-terahertz waves to person 100 from various angles. Emitter 20 may also be, for example, a surface light source, on a certain surface of which a plurality of sub-terahertz wave generating elements are arranged.

In the foregoing embodiment and variations, each of the elements such as controller 40 and image processor 90 may be configured in the form of an exclusive hardware product, or may be realized by executing a software program suitable for the element. Each of the elements may be realized by means of a program executing unit, such as a CPU and a processor, reading and executing the software program recorded on a recording medium such as a hard disk or a semiconductor memory.

Also, each of the elements may be a circuit (or an integrated circuit). Each of the circuits may be configured in the form of one circuit as a whole, or in the form of individual circuits. Each of the circuits may be a general-purpose circuit or an exclusive circuit.

These general and specific aspects of the present disclosure may be implemented using a system, an apparatus, a method, an integrated circuit, a computer program, or a non-transitory computer-readable recording medium such as a CD-ROM. Alternatively, these general and specific aspects of the present invention may be implemented as any combination of systems, apparatuses, methods, integrated circuits, computer programs, or non-transitory computer-readable recording media. For example, the present disclosure may be realized in the form of a program for causing a computer to execute control that is performed by a controller, etc., included in each of the elements of the imaging apparatus.

Also, the order of the processes in the operation that is performed by the imaging apparatus described in the foregoing embodiment and variations is one example. The order of the processes may be changed, and the processes may be executed in parallel.

In addition, various modification, replacement, addition, omission, etc., may be made to the foregoing embodiment and variations within the scope of the claims or the ranges equivalent to the scope.

### INDUSTRIAL APPLICABILITY

The present disclosure is widely applicable to imaging apparatuses that capture an image of an object.

1. An imaging apparatus that captures an image of an imaging target passing through a predetermined region, using a sub-terahertz wave, the imaging apparatus comprising:
an emitter that emits the sub-terahertz wave to the imaging target; and
a detection device that:
includes (i) an optical system that images a reflected wave which is the sub-terahertz wave emitted from the emitter and reflected by the imaging target and (ii) a plurality of pixels that are disposed in a planar arrangement and each receive the reflected wave imaged by the optical system; and
generates an image, based on cumulative intensities and the planar arrangement of the plurality of pixels, the cumulative intensities, each being obtained by accumulating an intensity of the reflected wave received by each of the plurality of pixels for a predetermined time,
wherein the predetermined time is λ/1778 seconds or longer, when a wavelength of the sub-terahertz wave is taken as A mm.

2. The imaging apparatus according to claim 1, comprising:
a detector that detects a traveling state of the imaging target passing through the predetermined region; and
a controller that controls an operation performed by the imaging apparatus when the traveling state is stationary.

3. The imaging apparatus according to claim 2,
wherein the controller determines the predetermined time based on the traveling state, and causes the detection device to generate the image based on the cumulative intensities accumulated for the predetermined time determined.

4. An imaging apparatus that captures an image of an imaging target passing through a predetermined region, using a sub-terahertz wave, the imaging apparatus comprising:
an emitter that emits the sub-terahertz wave to the imaging target;
a detection device that:
includes (i) an optical system that images a reflected wave which is the sub-terahertz wave emitted from the emitter and reflected by the imaging target and (ii) a plurality of pixels that are disposed in a planar arrangement and each receive the reflected wave imaged by the optical system; and
generates an image, based on cumulative intensities and the planar arrangement of the plurality of pixels, the cumulative intensities, each being obtained by accumulating an intensity of the reflected wave received by each of the plurality of pixels for a predetermined time;
a detector that detects a traveling state of the imaging target passing through the predetermined region; and
a controller that determines the predetermined time based on the traveling state, and causes the detection device to generate the image based on the cumulative intensities accumulated for the predetermined time determined.

5. The imaging apparatus according to claim 2,
wherein the detector detects, as the traveling state, a traveling speed at which the imaging target passes through the predetermined region, and
the controller determines that the traveling state of the imaging target is stationary when the traveling speed is less than a predetermined speed.

6. The imaging apparatus according to claim 2,
wherein the controller causes the detection device to stop generating the image when the traveling state is stationary.

7. The imaging apparatus according to claim 2, comprising:
a display that displays the image,
wherein the controller causes the display to stop displaying the image or to overlay another image onto the image when the traveling state is stationary.

8. The imaging apparatus according to claim 2, comprising:
an alarm that issues a warning,
wherein the controller causes the alarm to issue the warning when the traveling state is stationary.

9. The imaging apparatus according to claim 2, comprising:
a phase modulator that changes an angular distribution of a phase of the reflected wave to be received by each of the plurality of pixels in the detection device during an exposure period in which the detection device generates the image,
wherein the controller causes the phase modulator to change the angular distribution of the phase when the traveling state is stationary.

10. The imaging apparatus according to claim 9,
wherein the emitter includes:
a light source that emits the sub-terahertz wave; and
a reflector that diffusely reflects the sub-terahertz wave emitted from the light source to irradiate the imaging target with the sub-terahertz wave diffusely reflected, and
the phase modulator includes:
a phase difference plate that is disposed between the light source and the reflector, and changes a phase of the sub-terahertz wave that transmits through the phase difference plate; and
a phase difference plate driver that moves the phase difference plate under a predetermined condition.

11. The imaging apparatus according to claim 9,
wherein the phase modulator includes:
a phase difference plate that is disposed on an optical path of the reflected wave, between the predetermined region and the plurality of pixels in the detection device, and changes the phase of the reflected wave that transmits through the phase difference plate; and
a phase difference plate driver that moves the phase difference plate under a predetermined condition.

12. The imaging apparatus according to claim 9,
wherein the phase modulator forms at least part of the optical system,
the optical system includes, as the phase modulator, a mirror system that reflects the reflected wave to image the reflected wave onto the plurality of pixels in the detection device,
the mirror system includes a plurality of mirrors, and
each of the plurality of mirrors changes the phase of the reflected wave that is reflected during the exposure period of the detection device.

13. The imaging apparatus according to claim 9,
wherein the emitter includes:
a light source that emits the sub-terahertz wave; and
a reflector that diffusely reflects the sub-terahertz wave emitted from the light source to irradiate the imaging target with the sub-terahertz wave diffusely reflected, and
the phase modulator includes a light source driver that moves the light source under a predetermined condition to change the angular distribution of the phase.

14. The imaging apparatus according to claim 9,
wherein the emitter includes:
a light source that emits the sub-terahertz wave; and
a reflector that diffusely reflects the sub-terahertz wave emitted from the light source to irradiate the imaging target with the sub-terahertz wave diffusely reflected, and
the phase modulator includes a reflector driver that moves the reflector under a predetermined condition to change the angular distribution of the phase.

15. The imaging apparatus according to claim 9,
wherein the phase modulator includes a conveyer that moves the imaging target by half the wavelength of the sub-terahertz wave or more within the predetermined region during the exposure period of the detection device to change the angular distribution of the phase.

16. The imaging apparatus according to claim 1,
wherein the predetermined time is L/27800 seconds or less, when a shortest imaging distance in the detection device is taken as L mm.

17. The imaging apparatus according to claim 1,
wherein the predetermined time is a duration of an exposure period in one frame of the detection device.

18. The imaging apparatus according to claim 1,
wherein the predetermined time is λ/254 seconds or longer.

19. The imaging apparatus according to claim 1,
wherein a frequency of the sub-terahertz wave is between 0.05 THz and 2 THz, inclusive, and the wavelength of the sub-terahertz wave is between 0.15 mm and 6 mm, inclusive.

20. The imaging apparatus according to claim 1,
wherein the predetermined time is a duration of exposure periods in a plurality of frames of the detection device, and
the detection device includes a combiner that combines a signal of each of the plurality of pixels obtained in the plurality of frames to generate the image based on the cumulative intensities accumulated for the predetermined time, or accumulates, for the predetermined time, a signal of the reflected wave received by each of the plurality of pixels in the plurality of frames to generate the image based on the cumulative intensities accumulated for the predetermined time.
